(19) United States
(12) Patent Application Publication
(10) Pub. No.: US 2021/0354429 A1
(43) Pub. Date: Nov. 18, 2021

(54) DECORATED LAMINATE, OPTICAL LAMINATE, AND FLEXIBLE IMAGE DISPLAY DEVICE

(71) Applicant: Nitto Denko Corporation, Ibaraki-shi, Osaka (JP)

(72) Inventors: Yuta Watanabe, Ibaraki-shi, Osaka (JP); Takanobu Yano, Ibaraki-shi, Osaka (JP)

(73) Assignee: Nitto Denko Corporation, Ibaraki-shi, Osaka (JP)

(21) Appl. No.: 17/271,064

(22) PCT Filed: Aug. 21, 2020
(86) PCT No.: PCT/JP2020/031588

§ 371 Date: Feb. 24, 2021

(30) Foreign Application Priority Data
Dec. 26, 2019 (JP) 2019-237499

(51) Int. Cl. B32B 27/08

(52) U.S. Cl. CPC B32B 27/08; B32B 2457/208; B32B 2307/402; B32B 2457/206; B32B 2307/536; B32B 2457/202; B32B 2307/51

(57) ABSTRACT

A decorated laminate includes: a first member; a second member; and a tacky member sandwiched therebetween; and a decoration layer in contact with the tacky member. The first member is disposed closer to a viewing side than the second member. The first member and the second member do not include the tacky member. Where L10 is a position in a lamination direction of an interface between the first member and the tacky member at a center of the first member, L11 is a position in the lamination direction of a surface of the first member on the viewing side at the center, and L12 is a position closest to the viewing side of a portion of the first member that opposes the decoration layer, a height A1 from L10 to L11 and a height B1 from L10 to L12 satisfy a condition of A1<B1.

### TECHNICAL FIELD

The present invention relates to a decorated laminate for use in a flexible image display device, and an optical laminate and a flexible image display device that include the same.

### BACKGROUND ART

A flexible image display device includes, for example, a window member, an optical film, and a panel member including a display panel. The flexible image display device may further include a touch sensor. An adhesive layer or a tacky layer is disposed between or inside these members included in the flexible image display device. An optical laminate in a state in which the laminated structure of the flexible image display device except for the panel member is held by a separator may be used for assembly of a flexible image display device. For example, a flexible image display device can be formed by detaching the separator from the optical laminate, and bonding the optical laminate to a panel member.

In a flexible image display device or an optical laminate, a lead wire of a driving element or the touch sensor is present at the periphery of a display portion in which an image is displayed. Accordingly, the flexible image display device or the optical laminate is provided with a decoration layer such that the lead wire is not visible from the outside. Usually, the decoration layer is disposed closer to the viewing side than the touch sensor so as to be in contact with the tacky layer.

PTL 1 proposes an optical laminate including a front plate, a bonding layer, and a back plate in this order in the lamination direction, wherein the optical laminate further includes a colored layer provided on a part of a first surface of the back plate on the bonding layer side or a second surface of the back plate on a side opposite to the first surface. PTL 1 also proposes that the optical laminate further includes a shielding layer that is not in contact with the colored layer. PTL 1 describes an example in which a colored layer 40 is provided on a part of a surface of a polarizing plate 60a on the first bonding layer 20 side, and a shielding layer 50 is provided on a part of a surface of the polarizing plate 60a on the second bonding layer 21 side. In addition, PTL 1 also describes an example in which the colored layer 40 is provided between the polarizing plate 60a and a touch sensor 70 on a part of a surface of the touch sensor on the second bonding layer 21 side.

PTL 2 proposes an optical member including a polarizer, a retardation film, and a smoothing layer, wherein a print layer corresponding to the decoration layer is formed at a peripheral edge portion of the retardation film. PTL 2 describes that a liquid crystal display device includes the optical member, a liquid crystal cell, and a polarizing plate in this order from the viewing side.

### CITATION LIST

### Patent Literatures

[PTL 1] Japanese Laid-Open Patent Publication No. 2019-191560 (claims 1 and 2, FIGS. 6 and 8)

[PTL 2] Japanese Laid-Open Patent Publication No. 2016-65928 (claim 1, [0067])

### SUMMARY OF INVENTION

### Technical Problem

Provision of the decoration layer in a flexible image display device or an optical laminate allows a lead wire or the like to be concealed. However, the periphery of the side portions of the decoration layer may shine white when viewed from the viewing side, resulting in a deterioration in the appearance.

### Solution to Problem

A first aspect of the present invention relates to a decorated laminate for use in a flexible image display device, the decorated laminate including:

a first member; a second member; a tacky member sandwiched between the first member and the second member; and a decoration layer provided so as to be in contact with the tacky member,

wherein the first member is disposed closer to a viewing side than the second member in the flexible image display device,

the first member and the second member do not include the tacky member, and,

where L10 is a position in a lamination direction of an interface between the first member and the tacky member at a center of the first member when the first member is viewed from the viewing side in a state in which the decorated laminate is placed flat, L11 is a position in the lamination direction of a surface of the first member on the viewing side at the center, and L12 is a position closest to the viewing side of a portion of the first member that opposes the decoration layer, a height A1 from L10 to L11 and a height B1 from L10 to L12 satisfy a condition of A1<B1.

A second aspect of the present invention relates to an optical laminate including the above-described decorated laminate,

the optical laminate including:

a window member;

a member A laminated to the window member;

a member B laminated to the window member via the member A;

a separator laminated to the window member via the member A and the member B; and

a plurality of layers of tacky members including the tacky member in contact with the decoration layer,

wherein one of the member A and the member B is an optical film, and the other is a touch sensor,

the first member constitutes the window member or the optical film,

the second member constitute the window member, the optical film, the touch sensor, or the separator, and

the decoration layer is provided closer to the viewing side than the touch sensor.

A third aspect of the present invention relates to an optical laminate including the above-described decorated laminate,

the optical laminate including:

a window member;

an optical film laminated to the window member;

a separator laminated to the window member via the optical film; and

a plurality of layers of tacky members including the tacky member in contact with the decoration layer,

wherein the first member constitutes the window member or the optical film,

the second member constitutes the window member, the optical film, or the separator, and

the decoration layer is provided closer to the viewing side than the separator.

A fourth aspect of the present invention relates to a flexible image display device including the above-described decorated laminate,

the flexible image display device including:

a window member;

a member A laminated to the window member;

a member B laminated to the window member via the member A;

a member C laminated to the window member via the member A and the member B; and

a plurality of layers of tacky members including the tacky member in contact with the decoration layer,

wherein one of the member A and the member B is an optical film, and the other is a touch sensor,

the member C includes at least a panel member,

the first member constitutes the window member or the optical film,

the second member constitute the window member, the optical film, or the touch sensor, and

the decoration layer is provided closer to the viewing side than the touch sensor.

A fifth aspect of the present invention relates to a flexible image display device including the above-described decorated laminate,

the flexible image display device including:

a window member;

an optical film laminated to the window member;

a touch sensor-equipped panel member laminated to the window member via the optical film; and

a plurality of layers of tacky members including the tacky member in contact with the decoration layer,

wherein the first member constitutes the window member or the optical film,

the second member constitutes the window member, the optical film, or the touch sensor-equipped panel member, and

the decoration layer is provided closer to the viewing side than the touch sensor-equipped panel member.

### Advantageous Effects of Invention

It is possible to enhance the appearance of a flexible image display device or an optical laminate when a decoration layer is provided therein.

### BRIEF DESCRIPTION OF DRAWINGS

FIG. 1 is a schematic cross-sectional view indicating A1, B1, A2, and B2 of a decorated laminate according to a first embodiment.

FIG. 2 is a schematic cross-sectional view of a decorated laminate according to a second embodiment.

FIG. 3 is a schematic cross-sectional view of a decorated laminate according to a third embodiment.

FIG. 4 is a schematic cross-sectional view of a decorated laminate according to a fourth embodiment.

FIG. 5 is a schematic cross-sectional view of a decorated laminate according to a fifth embodiment.

FIG. 6 is a schematic cross-sectional view of a decorated laminate according to a sixth embodiment.

FIG. 7 is a schematic cross-sectional view of a flexible image display device.

FIG. 8 is a photograph of a decoration layer of a decorated laminate of Example 4 and the periphery of inner side portions thereof, taken from the viewing side.

FIG. 9A is a schematic cross-sectional view of a decorated laminate of Comparative Example 1.

FIG. 9B is a schematic cross-sectional view of a decorated laminate of Comparative Example 2.

FIG. 10 is a photograph of a decoration layer of a decorated laminate of Comparative Example 1 and the periphery of inner side portions thereof, taken from the viewing side.

### DESCRIPTION OF EMBODIMENTS

A flexible image display device or an optical laminate has a structure in which a plurality of constituent members are laminated. By disposing a tacky member between adjacent constituent members or inside each constituent member, the stress generated when bending the flexible image display device can be easily relaxed by the tacky member. This is because, unlike an adhesive member that bonds members or layers constituting the members by being cured, the tacky member has high viscosity even in a state in which the members or the layers are bonded together.

Note that the adhesive member is a cured adhesive, and does not have fluidity. On the other hand, the tacky member is a non-curable adhesive, and has fluidity.

In a flexible image display device or an optical laminate, a decoration layer can be provided so as to be in contact with the tacky member, for example. The decoration layer is provided so as to prevent a lead wire from being seen from the viewing side, and has a low visible light transmission. For this reason, in order to prevent the visibility of a panel member from being impaired, the decoration layer is provided, for example, at a portion on the outer edge side when viewed from the viewing side. In addition, from the viewpoint of ensuring high industrial productivity, the decoration layer and the tacky member are usually produced separately, and then are laminated and pressure-bonded. Because the tacky member has fluidity and high viscosity, the level difference due to the decoration layer provided at a portion of the tacky member can be absorbed by the tacky member to a certain degree. However, as a result of giving attention to a laminate including a first member and a second member disposed closer to the viewing side and a tacky member sandwiched between these members in the flexible image display device or the optical laminate, it has become evident that, when the decoration layer is provided so as to be in contact with the tacky member, the periphery of the side portions of the decoration layer may shine white when viewed from the viewing side, resulting in a deterioration in the appearance. Note that even in the case where the periphery of the side portions of the decoration layer shines white when viewed from the viewing side, the white shining phenomenon is hardly observed when the laminate is viewed from a side opposite to the viewing side. In the case where the periphery of the side portions of the decoration layer shines white, white shining lines are often observed along the inner side portions of the decoration layer.

A1 though the details of the mechanism by which the above-described white shining phenomenon occurs is unknown, the phenomenon is presumably caused by the following reasons. First, at the time of pressure-bonding the first member and the second member via the tacky member, if the decoration layer is disposed, stress is applied to portions of the first member, the second member, and the tacky member that oppose the decoration layer because the decoration layer has a thickness. Due to the fluidity and the viscosity of the tacky member, a certain amount of stress can be relaxed by the tacky member. However, not all of the stress is relaxed, and stress is applied to the first member and the second member. When a portion of the second member that opposes the decoration layer is pressed by the decoration layer, the second member is deformed into a state of being convex on the viewing side from the portion opposing the decoration layer toward the center when viewed from the viewing side. In particular, at the periphery of the side portions of the decoration layer, a large distortion is caused in the second member by the decoration layer, and the inclination of the surface of the second portion is increased at the convex portion. The phenomenon in which the periphery of the side portions of the decoration layer shines white when viewed from the viewing side is considered to occur because light rays from the viewing side are likely to be reflected at this convex surface portion having a large inclination

In view of such a problem, a decorated laminate according to the present invention is for use in a flexible image display device (or an optical laminate). The decorated laminate includes a first member, a second member, a tacky member sandwiched between the first member and the second member, and a decoration layer provided so as to be in contact with the tacky member. The first member is disposed closer to the viewing side than the second member in the flexible image display device. The first member and the second member do not include the tacky member. Where L10 is a position in a lamination direction of an interface between the first member and the tacky member at a center of the first member when the first member is viewed from the viewing side in a state in which the decorated laminate is placed flat, L11 is a position in the lamination direction of a surface of the first member on the viewing side at the above-described center, and L12 is a position closest to the viewing side of a portion of the first member that opposes the decoration layer, a height (or distance) A1 from L10 to L11 and a height (or distance) B1 from L10 to L12 satisfy a condition of A1<B1.

Note that as used herein, in the lamination direction (i.e., the average thickness direction of each member) of the members constituting the decorated laminate, the flexible image display device, or the optical laminate, the relative positional relationship between the members or the layers constituting each member may be expressed by using the expressions “viewing side” or “side opposite to the viewing side” of the flexible image display device or the optical laminate. As used herein, the decorated laminate refers to a laminate including the decoration layer.

In the above-described decorated laminate, a portion of the first member that opposes the decoration layer is deformed toward the viewing side. That is, the stress due to the decoration layer is absorbed by the first member by the deformation of the first member. By absorbing the stress due to the decoration layer by the first member, the stress applied to the second member is relatively reduced. This presumably reduces the deformation of the second member at the portion opposing the decoration layer, thus suppressing the reflection of light rays from the viewing side. As a result, it is possible to suppress the occurrence of the phenomenon in which the periphery of the side portions of the decoration layer shines white. Accordingly, it is possible to enhance the appearance when the decoration layer is provided.

Note that the phenomenon in which the periphery of the side portions of the decoration layer shines white is not observed when a portion of the first member that opposes the decoration layer is significantly deformed. This seems to be similar to the fact that the white shining phenomenon is not observed when viewed from the side opposite to the viewing side even if the white shinning phenomenon is observed when viewed from the viewing side. That is, even when a portion of the first member that opposes the decoration layer is deformed by being pressed by the decoration layer, a portion thereof on the outer edge side is deformed so as to protrude toward the viewing side. Accordingly, a portion of the first member that has a large surface inclination becomes a concave surface when viewed from the viewing side. It is considered that the white shining phenomenon is not observed because light rays from the viewing side are scattered on such a concave surface.

Note that the optical laminate is used for assembly of a flexible image display device in a state in which the separator is detached therefrom. Accordingly, when the second member is the separator, a significant deformation of the separator may not result in a significant deterioration in the appearance in the flexible image display device. There is a case, however, where the optical laminate is distributed by itself, and it is therefore desirable that the above-described white shining phenomenon is not observed in an optical laminate in which the second member is the separator.

In the decorated laminate, (B1−A1) representing the degree of deformation of the first member is preferably 1 μm or more. In this case, the effect of suppressing the deformation of the second member is further increased.

Where L20 is a position in the lamination direction of an interface between the second member and the tacky member at a center of the second member when the second member is viewed from the viewing side, L21 is a position in the lamination direction of a surface of the second member on a side opposite to the viewing side at the above-described center, L22 is a position farthest from the viewing side of a portion of the second member that opposes the decoration layer, A2 is a height (or distance) from L20 to L21, and B2 is a height (or distance) from L20 to L22, it is preferable that (B1−A1) and (B2−A2) are equivalent, or satisfy a condition of (B1−A1)>(B2−A2). In this case, the stress due to the decoration layer that absorbed by the second member can be reduced, and the stress can be more effectively absorbed by the first member. Accordingly, it is possible to further increase the effect of enhancing the appearance when the decoration layer is provided.

From the viewpoint that the stress due to the decoration layer that is absorbed by the second member can be reduced, and the stress can be more effectively absorbed by the first member, it is preferable that a condition of (B2−A2)≤5 μm is satisfied.

Note that the state in which the decorated laminate is placed flat is a state in which the decorated laminate (or a flexible image display device or an optical laminate including the decorated laminate) is placed on a horizontal base such that the lamination direction of the decorated laminate is parallel to the vertical direction.

(B1−A1) and (B2−A2) are each measured based on an image of a cross section of the decorated laminate, the flexible image display device, or the optical laminate that passes through the above-described center, and that cuts through the decoration layer. Images of such a cross-section can be captured using X-ray computed tomography (CT).

Where E1 is an elastic modulus (GPa) of the first member, and T1 is a thickness (mm) of the first member, R1 represented by E1×T1 preferably satisfies a condition of 0.5 kN/mm or less. A product R1 of the elastic modulus and the thickness indicates the degree of the hardness (or resilience) of the first member. By controlling the hardness of the first member within such a range, the stress due to the decoration layer can be more easily absorbed by the deformation of the first member. Accordingly, the effect of reducing the deformation of the second member can be further increased.

The balance between the stresses due to the decoration layer that are respectively absorbed by the first member and the second member can also be controlled by the hardness (or resilience) of each member. Where E2 is an elastic modulus (GPa) of the second member, and T2 is a thickness (mm) of the second member, a hardness R2 (or resilience) of the second member is represented by E2×T2. A1 so, it is preferable that the hardness R1 of the first member and the hardness R2 of the second member are equivalent, or satisfy a condition of R2>R1. Note that such a relationship has substantially the same meaning as the above-described relationship in which (B1−A1) and (B2−A2) are equivalent, or satisfy a condition of (B1−A1)>(B2−A2). In other words, when R1 and R2 are equivalent, it can be said that (B1−A1) and (B2−A2) are equivalent, and when R2>R1, it can be said that (B1−A1)>(B2−A2). The balance of deformation between the members can be adjusted by adjusting the balance of hardness between the members.

Note that R1 and R2 being equivalent refers to a range that satisfies a condition of 0.5≤R2/R1≤2. When R2>R1, the ratio R2/R1 is R2/R1>1. Accordingly, it can be said that the ratio R2/R1 satisfies R2/R1≥0.5. By satisfying R2/R1≥0.5, the deformation of the second member due to the decoration layer can be more effectively reduced.

R1 (kN/mm) preferably satisfies 0.01≤R1≤2.5. R2 (kN/mm) preferably satisfies 0.01≤R2≤2.5. When the hardness of each of the first member and the second member is in such a range, it is possible to easily disperse the stress due to the decoration layer between the first member and the second member in a well-balanced manner, while reducing the deformation of the second member.

When the ratio R2/R1 satisfies a condition of R2/R1>2, it can be said that the hardness of the second member is sufficiently larger than that of the first member. In this case, most of the stress due to the decoration layer can be absorbed by the first member, and it is therefore possible to more effectively suppress the deformation of the second member.

When the hardness R2 of the second member is relatively small, usually, the deformation of the second member is likely to be caused by the decoration layer. Even in such a case, when the ratio R2/R1 satisfies a condition of 0.5≤R2/R1≤2, the stress due to the decoration layer can be easily relaxed by the deformation of the first member. Accordingly, the deformation of the second member can be more effectively reduced. Here, each of R1 and R2 preferably satisfies a condition of 0.5 kN/mm or less.

Each of the elastic moduli E1 and E2 (GPa) of the first member and the second member is an average value (arithmetic mean value) obtained by preparing three measurement samples for each of the members, measuring the elastic modulus of each of the samples by a tensile test, and averaging the measured values. The tensile test can be performed under the following conditions, using the following device.

Tensile tester: Autograph AG-1S, manufactured by SHIMADZU CORPORATION

Control: stroke

Gauge length: 100 mm

Tensile speed: 50 mm/min

Elastic modulus calculation range: 10 N/mm² to 20 N/mm²

Note that the samples for measuring the elastic modulus are produced as follows. First, the longitudinal and lateral elastic moduli of each member are measured. Then, each member is cut into a strip form such that the length in the direction in which the elastic modulus is higher is 150 mm, and the length in the direction in which the elastic modulus is lower is 10 mm, whereby a sample is produced. To cut each member, a multi-purpose test piece cutter manufactured by DUMBBELL CO., LTD. is used, for example.

The hardnesses of the members or the balance therebetween can be adjusted, for example, by adjusting the material, layer configuration, and/or thickness of each member.

In the following, the configuration of the decorated laminate will be described more specifically.

(Decoration Layer)

In the decorated laminate, the decoration layer is provided so as to be in contact with the tacky member sandwiched between the first member and the second member. The decoration layer is disposed, for example, on at least one of a surface of the first member on the second member side and a surface of the second member on the first member side. From the viewpoint of easily reducing the deformation of the second member due to the decoration layer, the decoration layer is preferably disposed only one of a surface of the first member on the second member side and a surface of the second member on the first member side. Note that when the second member is the separator, the decoration layer is preferably disposed on the surface of the first member on the second member side.

In order to prevent the lead wire of a driving element or a touch sensor from being seen from the outside, the decoration layer is usually provided in a frame-shaped pattern at a portion in the vicinity of the outer edge of a display portion in which an image is displayed. However, the shape of the decoration layer is not limited to a frame shape, and may be any shape that can conceal the lead wire and the like.

In addition to not reflecting the light from the viewing side, the decoration layer is required to block the light from the side opposite to the viewing side. Such a decoration layer can be formed, for example, by an ink layer, a metal thin film, or a thin film containing metal fine particles. A thin film containing metal fine particles contains, for example, metal fine particles and a binder resin. The decoration layer may have a monolayer structure, or may have a laminated structure. The decoration layer having a laminated structure may be, for example, a laminate of at least two selected from an ink layer, a metal thin film, and a thin film containing metal fine particles. This laminate also includes a laminate including two or more ink layers having different compositions, two or more metal thin films having different compositions, or two or more thin films containing metal fine particles having different compositions.

From the viewpoint of easily reducing the deformation of the second member, the thickness of the decoration layer is preferably 20 μm or less, and may be 15 μm or less. From the viewpoint of more easily eliminating the level difference due to the decoration layer by the tacky member, the thickness of the decoration layer may be 10 μm or less, 8 μm or less, or 5 μm or less. When the thickness of the decoration layer is in such a range, high bendability of the flexible image display device can be easily ensured. From the viewpoint of ensuring higher effect of concealing the lead wire, the thickness of the decoration layer is preferably 10 nm or more, and more preferably 30 nm or more or 50 nm or more.

The above-described upper and lower limits of the thickness of the decoration layer may be combined in any combination.

The decoration layer may be formed, for example, by applying, to the above-described surface of the member on which the decoration layer is to be formed, a coating agent containing the constituent components of the decoration layer. Alternatively, the decoration layer may be formed by depositing, on the above-described surface of the member on which the decoration layer is to be formed, the constituent components by the gas phase method. In particular, in the case of a metal thin film, a decoration layer having a small thickness can be easily formed by using the gas phase method. Examples of the gas phase method include sputtering, vacuum evaporation, chemical vapor deposition (CVD), and electron-beam evaporation.

Prior to application of the coating agent, a primer layer may be disposed on the above-described surface of the member on which the decoration layer is to be formed. For example, when the decoration layer is provided on a surface of the first member on the second member side, a primer layer may be disposed between the decoration layer and the surface of the first member on the second member side. When the decoration layer is provided on a surface of the second member on the first member side, a primer layer may be disposed between the decoration layer and the surface of the second member on the first member side.

The primer layer includes at least one selected from the group consisting of, for example, a metal compound (a metal oxide, a metal nitride, a metal carbide, a metal sulfide, etc.), and a resin material. The primer layer is preferably transparent.

In addition to the fact that the level difference due to the decoration layer can be easily absorbed by the tacky member, from the viewpoint of easily suppressing the optical influence of the primer layer, the thickness of the primer layer is preferably small. The thickness of the primer layer is, for example, 500 nm or less, and preferably 100 nm or less, or 30 nm or less.

Note that when the decorated laminate is applied to a flexible image display device or an optical laminate, the decoration layer may be disposed so as to be in contact with at least one layer of a tacky member at a position closer to the viewing side than a touch sensor (or a touch sensor-equipped panel member), for example. When the second member is the separator in an optical laminate that does not include a touch sensor, the decoration layer may be disposed so as to be in contact with at least one layer of a tacky member at a position closer to the viewing side than the separator.

(Tacky Member)

In the decorated laminate, the decoration layer is disposed so as to be in contact with the tacky member, whereby the stress due to the decoration layer can be relaxed by the fluidity or viscosity of the tacky member.

From the viewpoint of easily ensuring higher effect of stress relaxation, the thickness of the tacky member is, for example, 3 μm or more, and may be 5 μm or more, or 6 or more. When the thickness of the layer of the tacky member is in such a range, high bendability in the flexible image display device can be easily ensured. The thickness of the tacky member may be 10 μm or more. In this case, the level difference due to the decoration layer can be easily absorbed, and it is possible to suppress generation of air bubbles in the vicinity of an end portion of the decoration layer.

From the viewpoint of easily absorbing the level difference due to the decoration layer, the thickness of the tacky member may be 1.5 times or more, or 2 times or more or 2.5 times or more, or even 3 times or more of the thickness of the decoration layer.

The thickness of the tacky member may be 50 μm or less, or may be 40 μm or less or 30 μm or less. When the thickness of the tacky member is in such a range, the stress due to the decoration layer is likely to be transmitted to the first member and the second member, and the second member is more likely to be deformed. However, by controlling the balance of deformation or hardness between the first member and the second member in the above-described manner, the deformation of the second member can be effectively suppressed even when the thickness of the tacky member is in such a range.

The above-described lower and upper limits of the thickness of the layer of the tacky member may be combined in any combination. For example, the thickness of the tacky member may be 10 μm or more and 50 μm or less (or 40 μm or less or 30 μm or less). The thickness of the tacky member may be 1.5 times or more of the thickness of the decoration layer, and 50 μm or less (or 40 μm or less or 30 μm or less).

The thickness of the tacky member is measured based on an X-ray CT image of a cross section of the decorated laminate, or the flexible image display device or the optical laminate including the decorated laminate. The thickness of the tacky member is determined by measuring the thickness at a plurality of arbitrary locations (e.g., five locations) for a portion of the tacky member that does not oppose the decoration layer in the above-described cross-sectional image, and averaging the measured values.

The storage modulus at 25° C. of the tacky member is usually 10 MPa or less, and may be 3 MPa or less, or may be 2 MPa or less, or 1.5 MPa or less. When the storage modulus of the tacky member is in such a range, high adhesion can be ensured. From the viewpoint of further increasing the effect of reducing the deformation of the second member by absorbing the level difference due to the decoration layer by the tacky member, the storage modulus at 25° C. of the tacky member is preferably 1 MPa or less.

The storage modulus at 25° C. of the tacky member may be 0.001 MPa or more, or may be 0.005 MPa or more.

The above-described upper and lower limits of the storage modulus of the tacky member may be combined in any combination.

Note that the storage modulus at 25° C. of the adhesive member is greater than 10 MPa, and may be 100 MPa or more, and usually about 1 GPa. As used herein, the adhesive member means an adhesive member having such a storage modulus. As such, the tacky member is differentiated from the adhesive member by the storage modulus.

The storage modulus of the tacky member can be measured in accordance with JIS K 7244-1:1998. Specifically, first, a shaped object having a thickness of about 1.5 mm is produced using the tacky member. The shaped object is punched into a disk shape with a diameter of 7.9 mm, to produce a test piece. The test piece is sandwiched between parallel plates, and viscoelasticity measurement is performed using a dynamic viscoelasticity measurement device (e.g., “Advanced Rheometric Expansion System (ARES)” manufactured by Rheometric Scientific LTD.) under the following conditions, to determine a storage modulus at 25° C. Note that the storage modulus of the adhesive member can also be determined similarly to that of the tacky member.

(Measurement Conditions)

Deformation mode: torsion

Measurement frequency: 1 Hz

Measurement temperature: −40° C. to +150° C.

Elevated temperature: 5° C./min

From the viewpoint of ensuring high visibility of the panel member, the total light transmittance of the tacky member is preferably 85% or more, and more preferably 90% or more.

The total light transmittance of the tacky member can be measured in accordance with JIS K 7136K: 2000. For the measurement, a test piece obtained by disposing the tacky member on alkali-free glass (thickness: 0.8 to 1.0 mm, total light transmittance: 92%) to a thickness of about 1.5 mm.

The tacky member is formed of a tackiness agent. The type of the tackiness agent is not particularly limited, and examples thereof include an acrylic tackiness agent, a rubber-containing tackiness agent, a silicone-containing tackiness agent, a urethane-series tackiness agent, a vinyl alkyl ether-series tackiness agent, a polyvinyl pyrrolidone-series tackiness agent, a polyacrylamide-series tackiness agent, and a cellulose-series tackiness agent. The tackiness agent may include, but is not limited to, for example, a base polymer, a crosslinking agent, an additive (e.g., a tackifier, a coupling agent, a polymerization inhibitor, a crosslinking retarder, a catalyst, a plasticizer, a softening agent, a filler, a colorant, metal powder, an ultraviolet absorber, a light stabilizer, an antioxidant, a degradation inhibitor, a surfactant, an antistatic agent, a surface lubricant, a leveling material, a corrosion inhibitor, particles of an inorganic or organic material (metal compound particles (metal oxide particles, etc.), resin particles, etc.).

The use of a tackiness agent that can provide the above-described storage modulus as the tackiness agent is advantageous because the stress due to the decoration layer can be easily relaxed.

The tacky member can be formed, for example, by applying the tackiness agent constituting the tacky member, or transferring a tackiness agent molded in a sheet form, to the surface of one of the first member and the second member. Then, by laminating the other of the first member and the second member to the tacky member, the tacky member is disposed between the first member and the second member. After the decoration layer has been formed on the surface of one of the first member and the second member, if the tackiness agent is applied so as to cover the decoration layer, the decoration layer may be disturbed. Therefore, usually, the decoration layer and the tacky member are separately produced, and then laminated. In this case, the problem of the deformation of the second member due to the decoration layer tends to occur. However, even in such a case, by controlling the balance of deformation or hardness between the first member and the second member in the above-described manner, the deformation of the second member can be effectively suppressed.

(First Member and Second Member)

According to the present invention, by controlling the balance of deformation or hardness between the first member and the second member in the above-described manner, excessive deformation of the second member is suppressed, and the deterioration in the appearance of the flexible image display device or the optical laminate when the decoration layer is provided is suppressed.

Each of the first member and the second member does not include the tacky member. Here, the tacky member refers to a tacky member having the above-described storage modulus at 25° C.

(B1−A1) is preferably 1 μm or more, and may be 2 μm or more, or may be 3 or more or 5 μm or more. When (B1−A1) is in such a range, the effect of suppressing the deformation of the second member can be further increased. From the viewpoint of easily ensuring high smoothness of a surface of the flexible image display device or the optical laminate on the viewing side, (B1−A1) is, for example, 10 μm or less.

(B2−A2) representing the degree of deformation of the second member is preferably 5 μm or less, and more preferably 3 μm or less. When (B2−A2) is in such a range, a better appearance can be ensured in the flexible image display device or the optical laminate. (B2−A2) may take a value of 0 μm or more.

As for the relationship in terms of the degree of deformation between the first member and the second member, it is preferable that (B1−A1) and (B2−A2) are equivalent, or satisfy a condition of (B1−A1)>(B2−A2). In particular, it is preferable that (B1−A1)≥(B2−A2). In such a case, a better appearance can be ensured in the flexible image display device or the optical laminate.

The hardness R1 of the first member is, for example, 0.01 kN/mm or more, and may be 0.05 kN/mm or more or 0.1 kN/mm or more. R1 is, for example, 2.5 kN/mm or less, or may be 1 kN/mm or less or 0.5 kN/mm or less, or may be 0.35 kN/mm or less or 0.3 kN/mm or less. When R1 is in such a range, the effect of absorbing the stress due to the decoration layer by the deformation of the first member is increased. These lower and upper limits may be combined in any combination

The hardness R2 of the second member is, for example, 2.5 kN/mm or less. R2 may be 1 kN/mm or less or 0.5 kN/mm or less, or may be 0.3 kN/mm or less. R2 is, for example, 0.01 kN/mm or more, and may be 0.05 kN/mm or more or 0.1 kN/mm or more. When R2 is in such a range, the hardnesses of the first member and the second member can be easily balanced, and the stress due to the decoration layer can be more easily absorbed by the deformation of the first member. These upper and lower limits may be combined in any combination.

When the ratio R2/R1 satisfies a condition of R2/R1>2, the deformation of the second member can be further effectively suppressed. The upper limit of the ratio R2/R1 in this case is not particularly limited. From the viewpoint of easily ensuring high bendability of the flexible image display device, the ratio R2/R1 may be 30 or less, or may be 20 or less or 16 or less.

When each of R1 and R2 is 0.5 kN/mm or less, the deformation of the second member can be more effectively reduced even with the range of 0.5≤R2/R1≤2. The ratio R2/R1 may be 0.5 to 1.5 or 0.5 to 1. Note that the respective lower limits of R1 and R2 can be selected from the above-described ranges.

Each of the first member and the second member may be a member constituting the flexible image display device or the optical laminate used therein, or one layer or a laminate of two or more layers constituting the member. Each of the first member and the second member may be determined taking into account the layer configuration according to the usage, and the balance of deformation or hardness between the above-described members.

The first member may specifically constitute a window member or an optical film. The second member may specifically constitute a window member, an optical film, a touch sensor, a touch sensor-equipped panel member, or a separator. Each of the first member and the second member may be a window member or an optical film, or may be one layer or a laminate of two or more layers constituting each of the window member and the optical film. The second member may be one layer or a laminate of two or more layers constituting a touch sensor, or may be a touch sensor, a touch sensor-equipped panel member, or a separator.

The first member and the second member may be combined in any combination selected from the above-described respective options, depending on the layer configuration of the desired flexible image display device or optical laminate. For example, an optical laminate usually has a configuration including a separator and not including a panel member. Accordingly, in the optical laminate, the second member may constitute a window member, an optical film, a touch sensor, or a separator. A flexible image display device usually has a configuration not including a separator and including a panel member. Accordingly, in the flexible image display device, the second member may constitute a window member, an optical film, a touch sensor, or a touch sensor-equipped panel member.

Note that the decorated laminate may include at least a first member, a second member, and a tacky member sandwiched between these members, and a decoration layer provided so as to be in contact with the tacky member. The decorated laminate may further include another member. For example, the combination of the first member and the second member is a combination of a first member constituting a window member and a second member constituting an optical film, the decorated laminate may further include at least one member selected from the group consisting of one layer or a laminate of two or more layers constituting the window member, one layer or a laminate of two or more layers constituting the optical film, a touch sensor (or a touch sensor-equipped panel member), and a separator. The decorated laminate may include a layer of a tacky member disposed at least either between constituent members or inside each constituent member. The decorated laminate may include, in addition to the tacky member (hereinafter also referred to as a first tacky member) disposed between the first member and the second member, two or more layers of tacky members (hereinafter also referred to as a second tacky member).

The configuration of the second tacky member is not particularly limited, and reference can be made to the description of the first tacky member. Reference can also be made to the description of the first tacky member as to the thickness of the second tacky member. Of the first tacky member and the second tacky member, the tackiness agents that constitute at least two layers of the tacky members may be the same, or the tackiness agents that constitute the tacky members may be different. The second tacky member can be formed in a similar way to the first tacky member.

The decorated laminate may include, in addition to a decoration layer (hereinafter also referred to as a first decoration layer) disposed so as to be in contact with the first tacky member, another decoration layer (hereinafter also referred to as a second decoration layer) disposed so as to be in contact with the second tacky member. The number of the second decoration layers may be one, or two or more. When the decorated laminate includes two or more second decoration layers, the second decoration layers are usually disposed so as to be in contact with different layers of the second tacky members. However, the invention is not limited to this case, and two second decoration layers may be disposed so as to be in contact with one second tacky member. As to the second decoration layer, reference can be made to the description of the first decoration layer.

In the following, each of the constituent members that may be the first member and the second member will be described more specifically.

(Window Member)

The window member is disposed on the outermost surface of a flexible image display device or an optical laminate on the viewing side in order to prevent breakage of an optical film, a touch sensor, a touch sensor-equipped panel member, and a panel member.

The window member usually includes at least one layer selected from the group consisting of a window film and a window glass. The flexible image display device or the optical laminate is required to have high flexibility (high pliability etc.), high transparency (a high total light transmittance and a low haze, etc.), and a high degree of hardness. The material of the window film or the window glass is not particularly limited as long as it satisfies these physical properties.

Examples of the window glass include a thin-glass substrate.

The thickness of the window glass is, for example, 5 μm or more and 40 μm or less, and may be 10 μm or more and 35 μm or less. When the window glass has such a thickness, both high strength and high bendability can be achieved simultaneously.

Examples of the window film include a transparent resin film. Examples of the resin that constitutes the transparent resin film include at least one selected from a polyimide-based resin, a polyamide-based resin, a polyester-based resin, a cellulose-series resin, an acetate-series resin, a styrene-series resin, a sulfone-series resin, an epoxy-series resin, a polyolefin-based resin, a polyether ether ketone-based resin, a sulfide-series resin, a vinyl alcohol-series resin, a urethane-series resin, an acrylic resin, and a polycarbonate-based resin. However, the resin that constitutes the transparent resin film is not limited thereto.

The thickness of the window film is, for example, 20 μm or more and 500 μm or less, and may be 30 μm or more and 200 μm or less. When the window film has such a thickness, both high strength and high bendability can be easily achieved simultaneously.

As used herein, “being transparent” when used for a member (shaped body) other than the tacky member or a material other than the tackiness agent means that a test piece of that member or material has a total light transmittance of 80% or more. For the measurement of the total light transmittance, a test piece formed of a transparent material or member and having a thickness of about 1.5 mm is used. The total light transmittance can be measured similarly to that of the tacky member.

The window member may include a hard coat layer. The hard coat layer is usually laminated with a window film. From the viewpoint of easily achieving high effect of preventing breakage of the window film, the hard coat layer is preferably provided at least on a surface of the window film on the viewing side.

The thickness of the hard coat layer is, for example, 1 μm or more and 100 μm or less, and may be 1 μm or more and 50 μm or less. When the window member includes a plurality of hard coat layers, the thickness of each hard coat layer may be set within such a range.

The hard coat layer is formed, for example, by applying a curable coating agent to the surface of an underlying layer (e.g., a window film), and curing the applied coating agent.

As the coating agent, a coating agent for use in an optical film can be used. Examples of the coating agent include, but are not are limited to, an acrylic coating agent, a melamine-series coating agent, a urethane-series coating agent, an epoxy-series coating agent, a silicone-containing coating agent, and an inorganic substance-containing coating agent.

The coating agent may contain an additive. Examples of the additive include, but are not limited to, a silane coupling agent, a colorant, a dye, powder or particles (a pigment, an inorganic or organic filler, particles of an inorganic or organic material, etc.), a surfactant, a plasticizer, an antistatic agent, a surface lubricant, a leveling agent, an antioxidant, a light stabilizer, an ultraviolet absorber, a polymerization inhibitor, and an anti-fouling material.

The window member may include another layer (hereinafter referred to as a layer Aw) as needed. Examples of the layer Aw include an antireflection layer, an antiglare layer, an anti-fouling layer, an anti-sticking layer, a hue adjustment layer, an antistatic layer, an easily adhesive layer, a layer for preventing precipitation of ion or an oligomer or the like, a shock-absorbing layer, and an anti-splinter layer. The window member may include one layer Aw, or a plurality of layers Aw. The layer Aw is provided, for example, on a surface on the viewing side or a surface on a side opposite to the viewing side of one layer (e.g., a window film or a window glass) or a laminate of two or more layers (e.g., a laminate of a window film and a hard coat layer) constituting a window member. The layer Aw may be directly formed using a coating or the like on the surface constituting the window member, or may be laminated thereto via an adhesive member or a tacky member.

Each of the first member and the second member may constitute a window member. More specifically, the first member may be a window member, or may be one layer or a laminate of two or more layers constituting a window member. Alternatively, the first member, the second member, and the decoration layer and the tacky member disposed therebetween may together constitute a window member.

Note that although the window member may include the tacky member, each of the first member and the second member does not include the tacky member. Therefore, when the window member includes the tacky member, a block of the laminated structure constituting the window member that does not include the tacky member (more specifically, one layer other than the tacky member or a laminate of two or more layers that do not include the tacky member) corresponds to the first member or the second member.

A thickness Tw of the window member is, for example, 0.02 mm or more and 0.6 mm or less, and may be 0.03 mm or more and 0.3 mm or less.

The thickness Tw of the window member, and the thickness of layers or two or more laminates constituting the window member are measured based on an X-ray CT image of a cross section of the decorated laminate, the flexible image display device or the optical laminate including the decorated laminate. The thickness Tw of the window member, and the thickness of layers or two or more laminates constituting the window member are determined by measuring the thickness at a plurality of arbitrary locations (e.g., five locations) in the above-described cross-sectional image, and averaging the measured values.

Note that as used herein, the thickness of a member constituting the decorated laminate, the optical laminate or the flexible image display device including the decorated laminate, or the thickness of layers or two or more laminates constituting the member can be determined similarly to the thickness Tw of the window member and the thickness of the layers or two or more laminates constituting the window member.

An elastic modulus Ew of the window member is, for example, 0.53 GPa or more and 16 GPa or less, and may be 1 GPa or more and 15 GPa or less, 1 GPa or more and 10 GPa or less, or 3 GPa or more and 8 GPa or less.

However, when the first member or the second member constitutes the window member, each of Ew and Tw is adjusted within the above-described range such that R1 indicating the hardness of the first member or R2 indicating the hardness of the second member is in the above-described range.

(Optical Film)

An optical film is a film having an optical function. An optical film is usually a laminate including at least one layer having an optical function. Examples of the optical film include those used in fields such as that of image display devices. In a flexible image display device or an optical laminate, the first member and the second member included in the decorated laminate may each constitute an optical film. Specifically, each of the first member and the second member may be an optical film, or may be one layer or a laminate of two or more layers constituting an optical film.

For example, when the first member is an optical film, or one layer or a laminate of two or more layers constituting an optical film, the second member may be one layer or a laminate of two or more layers constituting an optical film, a touch sensor, a touch sensor-equipped panel member, or a separator. When the second member is an optical film, or one layer or a laminate of two or more layers constituting an optical film, the first member may constitute a window member, or may be one layer or a laminate of two or more layers constituting an optical film.

Examples of the layer having an optical function include a layer having optical anisotropy (e.g., an optical anisotropic film). Examples of the layer having optical anisotropy include, but are not limited to, a polarizer, a retardation layer, a viewing angle expansion film, a viewing angle limiting (anti-peek) film, a brightness enhancement film, and an optical compensation film. The laminate of two or more layers may include two or more layers selected from these layers having optical anisotropy. In the laminate of two or more layers, all layers having optical anisotropy may have different functions, or at least two layers may have the same function. For example, the laminate may include a polarizer and a retardation layer, or may include two retardation layers having different compositions.

The optical film may include at least one layer having an optical function and a base material layer that holds (or a protection layer that protects) this layer. For example, a laminate of a polarizer in the form of a layer and a base material layer that holds the polarizer is called a polarizing plate. The optical film may include at least a polarizer or a polarizing plate.

Of the above-described layers having optical anisotropy, the optical film may include a polarizer, at least one layer having optical anisotropy other than the polarizer (hereinafter referred to as a layer Bo), and optionally at least one base material layer. The optical film may include a laminate of a polarizer and a base material layer as a polarizing plate.

The layer Bo may be laminated to the polarizing plate via the base material layer, or may be laminated to the polarizer without the base material layer interposed therebetween In the latter case, the layer Bo also has the function of holding or protecting the polarizer as the base material layer.

The polarizer is not particularly limited, and any polarizer used in fields such as that of image display devices can be used. Examples of the polarizer include a film obtained by causing a hydrophilic polymer film to adsorb a dichroic substance, and uniaxially stretching the film, and a polyene-based oriented film. Examples of the hydrophilic polymer that constitutes the hydrophilic polymer film include a polyvinyl alcohol-based resin (also including a partially formalized polyvinyl alcohol-based resin), and a partially saponified product of an ethylene-vinyl acetate copolymer. Examples of the dichroic substance include iodine and a dichroic dye. Examples of the material that constitutes the polyene-based oriented film include a dehydrated product of a polyvinyl alcohol-based resin and a dehydrochlorinated product of a polyvinyl chloride-based resin.

As the polarizer, a thin polarizer having a thickness of 10 μm or less may be used. Examples of the thin polarizer include polarizers described in Japanese Laid-Open Patent Publication No. 51-069644, Japanese Laid-Open Patent Publication No. 2000-338329, WO 2010/100917, Japanese Patent No. 4691205, and Japanese Patent No. 4751481. The thin polarizer is obtained, for example, by a production method including the steps of stretching a polyvinyl alcohol-based resin layer and a resin base material layer in a laminated state, and dyeing the layers using a dichroic material.

The thickness of the polarizing plate is, for example, 200 μm or less. From the viewpoint of easily ensuring higher bendability, the thickness of the polarizing plate is preferably 100 μm or less, and more preferably 80 μm or less or 70 μm or less. The thickness of the polarizing plate is, for example, 10 μm or more.

The thickness of the layer Bo is, for example, 0.1 μm or more and 100 μm or less. When the polarizer is laminated to the layer Bo without the base material layer interposed therebetween (i.e., when the layer Bo has the function of holding or protecting the polarizer), it is preferable to adjust the thickness of the layer Bo such that the thickness of the laminate of the layer Bo and the polarizer is in the range described for the thickness of the polarizing plate.

As the base material layer, a thin-glass substrate, a polymer film, or the like is used. As the polymer film, a polymer film that is excellent in transparency, mechanical strength, thermal stability, moisture barrier properties, and optical isotropy is used, for example. Examples of the polymer material having such properties include at least one selected from the group consisting of a cellulose-series resin, a polyolefin-based resin (also including a cyclic polyolefin-based resin), an acrylic resin, an imide-series resin (also including a phenyl maleimide-series resin), a polyamide-based resin, a polycarbonate-based resin, a polyester-based resin (also including a polyarylate-based resin), an acetate-series resin, a polyether sulfone-based resin, a polyvinyl chloride-based resin, a polyvinylidene chloride-based resin, a polystyrene-based resin, a polyvinyl alcohol-based resin, a sulfide-series resin (e.g., a polyphenylene sulfide-based resin), a polyether ether ketone-based resin, an epoxy-series resin, and a urethane-series resin. However, the polymer material that constitutes the base material layer is not limited thereto.

The optical film may include one base material layer, or two or more base material layers. The base material layer may be disposed on one surface of one layer having an optical function, or may be disposed on both surfaces thereof. The base material layer may include two or more layers having an optical function and including a base material layer disposed on one surface thereof. When two or more base material layers are included in the optical film, the compositions of all base material layers may be different, or the compositions may be the same in at least two base material layers.

Note that the layer constituting the optical film may be directly laminated to an adjacent layer, using a coating or the like. Alternatively, the layer constituting the optical film may be laminated to an adjacent layer via the adhesive member or the tacky member. Each of the first member and the second member does not include the tacky member. Accordingly, when the optical film includes the tacky member, a block of the laminated structure constituting the optical member that does not include the tacky member (more specifically, one layer other than the tacky member or a laminate of two or more layers that do not include the tacky member) corresponds to the first member or the second member.

A thickness To of the optical film is, for example, 0.005 mm or more and 0.5 mm or less, and may be 0.01 mm or more and 0.1 mm or less.

An elastic modulus Eo of the optical film is, for example, 0.001 GPa or more and 100 GPa or less, and may be 1 GPa or more and 80 GPa or less.

However, when the first member or the second member constitutes the optical film, each of Eo and To is adjusted within the above-described range such that R1 indicating the hardness of the first member or R2 indicating the hardness of the second member is in the above-described range.

(Touch Sensor)

As the touch sensor, for example, a touch sensor used in fields such as that of image display devices is used. Examples of the touch sensor include, but are not limited to, a resistive film touch sensor, a capacitive touch sensor, an optical touch sensor, and an ultrasonic touch sensor. When the optical film is present between the touch sensor and the window member in a flexible image display device and an optical laminate, high sensitivity can be easily achieved by using a capacitive touch sensor.

A capacitive touch sensor usually includes a transparent conductive layer. Examples of such a touch sensor include a laminate of a transparent conductive layer and a transparent base material. Examples of the transparent base material include a transparent film.

A1 though not by way of limitation, a conductive metal oxide, a metal nanowire, or the like is used for the transparent conductive layer. Examples of the metal oxide include indium oxide containing tin oxide (indium tin oxide: ITO), and tin oxide containing antimony. The transparent conductive layer may be a conductive pattern formed of a metal oxide or a metal. Examples of the form of the conductive pattern include, but are not limited to, a stripe form, a square form, and a grid form.

The surface resistance value of the transparent conductive layer is, for example, 0.1Ω/□ or more and 1000Ω/□ or less, and may be 0.5Ω/□ or more and 500Ω/□ or less.

The thickness of the transparent conductive layer is, for example, 0.005 μm or more and 10 μm or less, and may be 0.01 μm or more and 3 μm or less.

As the transparent film, a transparent resin film is used, for example. Examples of the resin that constitutes the transparent resin film include a polyester-based resin (also including a polyarylate-based resin), an acetate-series resin, a polyether sulfone-based resin, a polycarbonate-based resin, a polyamide-based resin, a polyimide-based resin, a polyolefin-based resin, an acrylic resin, a polyvinyl chloride-based resin, a polyvinylidene chloride-based resin, a polystyrene-based resin, a polyvinyl alcohol-based resin, a sulfide-series resin (e.g., a polyphenylene sulfide-based resin), a polyether ether ketone-based resin, a cellulose-series resin, an epoxy-series resin, and a urethane-series resin. The transparent resin film may include one kind, or two or more kinds of these resins. Among these resins, a polyester-based resin, a polyimide-based resin, and a polyether sulfone-based resin are preferable. However, the resin that constitutes the transparent resin film is not limited to these resins.

From the viewpoint of increasing the adhesion between the transparent conductive layer and the transparent base material, a surface-treated transparent base material may be used. As the surface treatment, a known surface treatment can be adopted. If necessary, prior to lamination of the transparent conductive layer, the transparent base material may be subjected to, for example, dust removal or cleaning treatment (such as washing treatment using a solvent, ultrasonic waves, or the like).

The touch sensor may include a layer (hereinafter referred to as a layer Ct) other than the transparent conductive layer and the transparent base material as needed. For example, an undercoat layer or a layer for preventing precipitation of an oligomer may be provided between the transparent conductive layer and the transparent base material as the layer Ct. Alternatively, the layer Ct may be laminated to at least one surface of each of the transparent conductive layer and the transparent base material. Examples of the layer Ct include functional layers having a desired function (e.g., layers having the above-described optical functions (a layer having optical anisotropy, etc.)). However, the layer Ct is not limited to these layers. The layer Ct may be laminated to the transparent conductive layer or the transparent base material via the adhesive member or the tacky member as needed.

An overall thickness Tt of the touch sensor is, for example, 0.005 mm or more and 0.25 mm or less, and may be 0.01 mm or more and 0.2 mm or less.

An elastic modulus Et of the touch sensor is, for example, 1 GPa or more and 10 GPa or less, and may be 3 GPa or more and 8 GPa or less.

However, when the second member constitutes a touch sensor, each of Et and Tt is adjusted within the above-described range such that R1 indicating the hardness of the first member or R2 indicating the hardness of the second member is in the above-described range.

(Touch Sensor-Equipped Panel Member) A touch sensor-equipped panel member is formed by integrating a touch sensor and a panel member in a single piece. Such a touch sensor-equipped panel member encompasses, for example, a touch sensor-equipped panel member having a configuration in which a capacitive touch sensor including a metal mesh electrode is formed on a thin-film sealing layer of an organic light emitting diode (OLED). As to the touch sensor, reference may be made to the above-described description. However, the touch sensor-equipped panel member does not include the tacky member.

The panel member includes at least an image display panel, for example. A sealing member (a thin-film sealing layer or the like) may be disposed on the viewing side of the image display panel. The sealing member is usually directly disposed on a surface of the image display panel on the viewing side.

As the image display panel, a known image display panel is used. Examples of the image display panel include an organic electroluminescence (EL) panel.

The touch sensor-equipped panel member may include a protection member. Examples of the protection member include a sheet or film (or substrate) that holds or protects the panel member. The protection member may be any member having a suitable strength for holding the panel member and protecting the panel member, and a suitable flexibility that does not prevent bending of the flexible image display device. Examples of the protection member include a resin sheet. The material of the resin sheet is not particularly limited, and can be selected as appropriate according to, for example, the type of the image display panel.

An overall thickness Tp of the touch sensor-equipped panel member is, for example, 0.005 mm or more and 0.1 mm or less, and may be 0.01 mm or more and 0.05 mm or less.

An elastic modulus Ep of the touch sensor-equipped panel member is, for example, 1 GPa or more and 10 GPa or less, and may be 3 GPa or more and 8 GPa or less.

When the second member is the touch sensor-equipped panel member, each of Ep and Tp is adjusted such that Ep×Tp indicating the hardness of the touch sensor-equipped panel member is in the above-described range of R2.

(Separator)

As the separator, a release sheet including a base material sheet and a release agent disposed on at least one surface of the base material sheet is used, for example. The separator is disposed in a state in which the release agent is in contact with the tacky member. When the second member is a separator, the separator is disposed in a state in which the release agent is in contact with the first tacky member.

The base material sheet may be any base material sheet that has suitable strength and flexibility, and on which a layer of the release agent can be easily formed. As the base material sheet, a resin film, paper, or a laminate thereof is used. The material of the base material sheet is determined according to the type of the release agent, the configuration of the optical laminate, and the like. As the resin film, a polyester film (a polyethylene terephthalate film or the like), a polyolefin film (a polypropylene film or the like) may be used, for example. The thickness of the base material sheet is also not particularly limited, and can be selected taking the desired releasability into account. As the release agent, a known release agent can be used, and it is preferable to select a release agent that reduces the residual amount of the tacky member in the separator. For example, a silicone-containing release agent or a fluorine-containing release agent may be used.

A thickness Ts of the separator is, for example, 0.01 mm or more and 1 mm or less, and may be 0.05 mm or more and 0.5 mm or less.

An elastic modulus Es of the separator is, for example, 0.001 GPa or more and 100 GPa or less, and may be 1 GPa or more and 80 GPa or less.

When the second member is the separator, each of Es and Ts is adjusted such that Es×Ts indicating the hardness of the separator is in the above-described range of R2.

The decorated laminate is produced, for example, by disposing the decoration layer on one surface of one member of the first member and the second member, disposing the tacky member on one surface of the other member, placing the first member and the second member on top of another such that the tacky member and the decoration layer are in contact with each other, and pressurizing the first member and the second member in the thickness direction. The first member and the second member are bonded together by being pressurized in a state in which the tacky member is interposed therebetween in this manner. A decorated laminate that has been produced in advance may be used for production of a flexible image display device or an optical laminate. Alternatively, the decorated laminate may be formed in the process of producing a flexible image display device or an optical laminate by laminating the constituent members or layers of the flexible image display device or the optical laminate.

A decorated laminate further including another member or layer is produced by laminating members or layers with a tacky member interposed between adjacent members or adjacent layers. The order of lamination is not particularly limited.

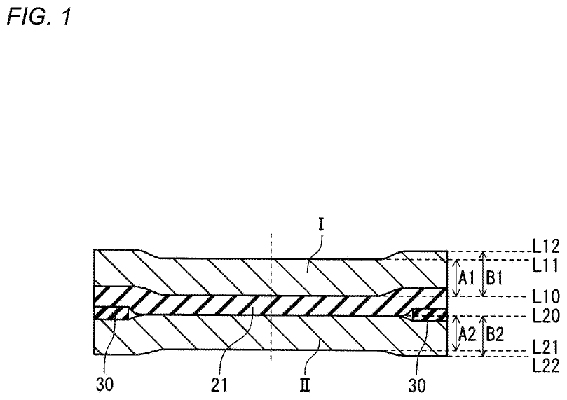

FIGS. 1 to 6 show embodiments of the decorated laminate according to the present invention. However, the decorated laminate is not limited to these embodiments.

FIG. 1 is a schematic cross-sectional view of a decorated laminate according to a first embodiment. The decorated laminate includes a first member I, a second member II, a tacky member (first tacky member) 21 interposed between the first member I and the second member II, and a frame-shaped decoration layer 30 disposed so as to be in contact with the tacky member 21. The decoration layer 30 is disposed on a surface of the second member II on the first member I side. However, the embodiment is not limited to this case, and the decoration layer 30 may be disposed on a surface of the first member I on the second member II side. Where L10 is a position in a lamination direction of an interface between the first member I and the tacky member 21 at a center of the first member I when the first member I is viewed from the viewing side of a flexible image display device in a state in which the decorated laminate is placed flat, L11 is a position in the lamination direction of a surface of the first member I on the viewing side at the above-described center, and L12 is a position closest to the viewing side of a portion of the first member I that opposes the decoration layer 30, a height (or distance) A1 from L10 to L11 and a height (or distance) B1 from L10 to L12 satisfies a condition of A1<B1.

L20 is a position in the lamination direction of an interface between the second member II and the tacky member 21 at a center of the second member II when the second member II is viewed from the viewing side of the flexible image display device, L21 is a position in the lamination direction of a surface of the second member II on a side opposite to the viewing side at the above-described center, L22 is a position farthest from the viewing side of a portion of the second member II that opposes the decoration layer 30, A2 is a height (or distance) from L20 to L21, and B2 is a height (or distance) from L20 to L22. In this case, it is preferable that (B1−A1) and (B2−A2) are equivalent, or satisfy a condition of (B1−A1)>(B2-A2).

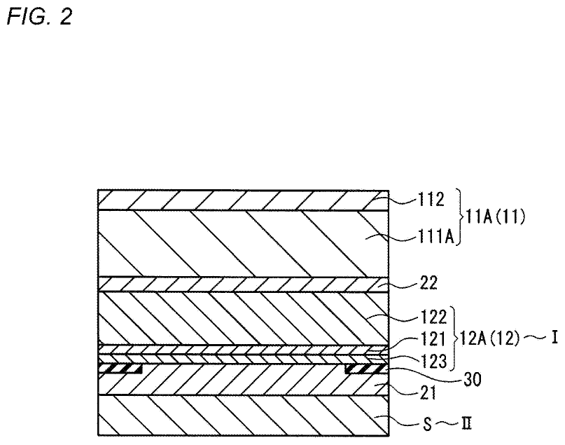

FIG. 2 is a schematic cross-sectional view of a decorated laminate according to a second embodiment. The decorated laminate according to the second embodiment includes an optical film 12 as a first member I, a separator S as a second member II, a tacky member (first tacky member) 21 interposed between the optical film 12 and the separator S. A frame-shaped decoration layer 30 is provided on a surface (surface on a side opposite to the viewing side) of the first member I on the second member II side in a state in which the decoration layer 30 is in contact with the tacky member 21. However, the embodiment is not limited to this case, and the decoration layer 30 may be provided on a surface of the second member II on the first member I side. A window member 11 is laminated to a surface of the optical film 12 on the viewing side via a tacky member (second tacky member) 22.

The window member 11 is, for example, a laminate 11A of a window film 111A, and a hard coat layer 112 laminated to the window film 111A. The hard coat layer 112 is provided on a surface of the window film 111A on the viewing side.

The optical film 12 is a laminate 12A of a polarizing plate composed of a polarizer 121 and a base material layer (protection film) 122, and a retardation layer 123. The retardation layer 123 is disposed on the touch sensor 13 side, and is laminated on the polarizer 121 side of the polarizing plate.

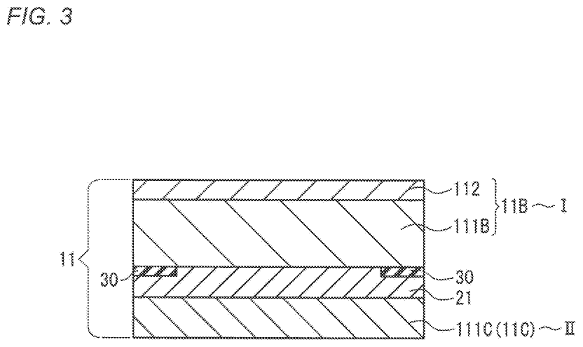

FIG. 3 is a schematic cross-sectional view of a decorated laminate according to a third embodiment. The decorated laminate of the third embodiment is a window member 11. The window member 11 as the decorated laminate includes a laminate 11B of two layers as a first member I, one layer 11C as a second member II, and a tacky member 21 interposed between the laminate 11B and the layer 11C. A frame-shaped decoration layer 30 is provided on a surface (surface on a side opposite to the viewing side) of the first member I on the second member II side in a state in which the decoration layer 30 is in contact with the tacky member 21. However, the embodiment is not limited to this case, and the decoration layer 30 may be provided on a surface of the second member II on the first member I side.

The layer 11C is, for example, a thin-glass substrate. The laminate 11B includes, for example, a window film 111B, and a hard coat layer 112 laminated to the window film 111B. The hard coat layer 112 is provided on a surface of the window film 111B on the viewing side.

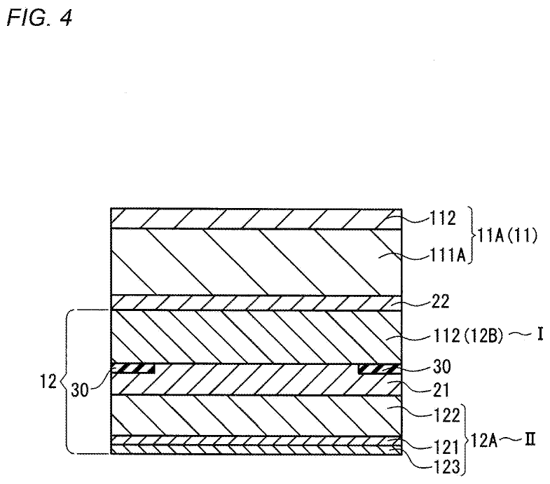

FIG. 4 is a schematic cross-sectional view of a decorated laminate according to a fourth embodiment. The decorated laminate of the fourth embodiment includes a window member 11, an optical film 12, and a tacky member (second tacky member) 122 interposed therebetween. The window member 11 is, for example, a laminate 11A of a window film 111A and a hard coat layer 112. The optical film 12A includes a layer 12B as a first member I, a laminate 12A as a second member II, and a tacky member (first tacky member) 21 interposed between the layer 12B and the laminate 12A. A frame-shaped decoration layer 30 is provided on a surface (surface on a side opposite to the viewing side) of the first member I on the second member II side in a state in which the decoration layer 30 is in contact with the tacky member 21. However, the embodiment is not limited to this case, and the decoration layer 30 may be provided on a surface of the second member II on the first member I side. The layer 12B is a transparent resin film.

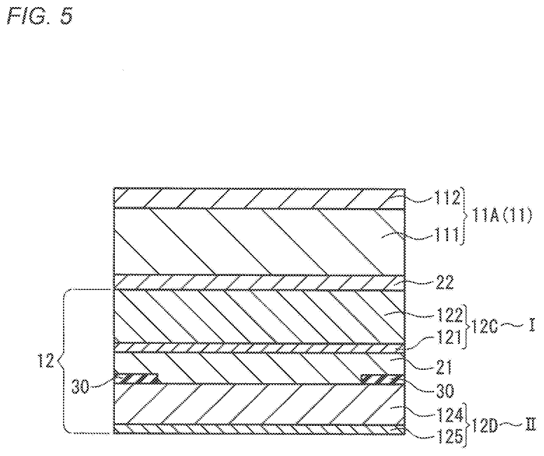

FIG. 5 is a schematic cross-sectional view of a decorated laminate according to a fifth embodiment. The decorated laminate of the fifth embodiment includes a window member 11, an optical film 12, and a tacky member (second tacky member 22) interposed therebetween. The optical film 12 includes a laminate 12C as a first member I, a laminate 12D as a second member II, and a tacky member (first tacky member) 21 interposed between the laminates 12C and 12D. A frame-shaped decoration layer 30 is provided on a surface (surface on the viewing side) of the second member II on the first member I side in a state in which the decoration layer 30 is in contact with the tacky member 21.

The laminate 12C is a polarizing plate composed of a polarizer 121 and a base material layer (protection film) 122. The polarizer 121 is disposed on the tacky member 21 side. The laminate 12D is a laminate of two retardation layers 124 and 125.

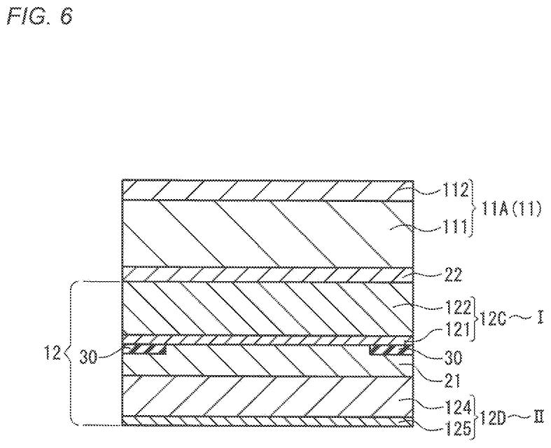

FIG. 6 is a schematic cross-sectional view of a decorated laminate according to a sixth embodiment. In the decorated laminate of the sixth embodiment, a frame-shaped decoration layer 30 is provided on a surface (surface on a side opposite to the viewing side) of a first member I on the second member II side in a state in which the decoration layer 30 is in contact with the tacky member 21. The rest of the configuration is the same as that of the fifth embodiment.

[Flexible Image Display Device and Optical Laminate]

Each of the flexible image display device and the optical laminate according to the present invention includes the above-described decorated laminate.

More specifically, a flexible image display device according to an embodiment includes a window member, a member A laminated to the window member, a member B laminated to the window member via the member A, a member C laminated to the window member via the member A and the member B, and a plurality of layers of tacky members including a tacky member in contact with the decoration layer. One of the member A and the member B is an optical film, and the other is a touch sensor. The member C includes at least a panel member. Here, the first member of the decorated laminate constitutes the window member or the optical film. The second member constitutes the window member, the optical film, or the touch sensor. The decoration layer is provided closer to the viewing side than the touch sensor.

A flexible image display device according to another embodiment includes a touch sensor-equipped panel member. More specifically, the flexible image display device includes a window member, an optical film laminated to the window member, a touch sensor-equipped panel member laminated to the window member via the optical film, and a plurality of layers of tacky members including a tacky member in contact with the decoration layer. Here, the first member of the decorated laminate constitutes the window member or the optical film. The second member constitutes the window member, the optical film, or the touch sensor-equipped panel member. The decoration layer is provided closer to the viewing side than the touch sensor-equipped panel member.

The present invention also encompasses an optical laminate that includes the above-described decorated laminate, and that is for use in a flexible image display device.

An optical laminate according to an embodiment of the present invention includes a window member, a member A laminated to the window member, a member B laminated to the window member via the member A, a separator laminated to the window member via the member A and the member B, and a plurality of layers of tacky members including a tacky member in contact with the decoration layer. One of the member A and the member B is the optical film, and the other is the touch sensor. Here, the first member of the decorated laminate constitutes the window member or the optical film. The second member constitutes the window member, the optical film, the touch sensor, or the separator. The decoration layer is provided closer to the viewing side than the touch sensor.

An optical laminate according to another embodiment of the present invention includes a window member, an optical film laminated to the window member, a separator laminated to the window member via the optical film, and a plurality of layers of tacky members including a tacky member in contact with the decoration layer. Here, the first member of the decorated laminate constitutes the window member or the optical film. The second member constitutes the window member, the optical film, or the separator. The decoration layer is provided closer to the viewing side than the separator.

Note that in the flexible image display device or the optical laminate, the tacky member that is provided between the first member and the second member, and that is in contact with the decoration layer corresponds to the above-described first tacky member. The plurality of layers of tacky members correspond to the first tacky member and the second tacky member.

The optical laminate is used for a flexible image display device in a state in which the separator is detached from the optical laminate. The above-described flexible image display device includes the optical laminate with the separator detached therefrom in a state in which the window member is disposed on the viewing side.

(Panel Member)

As to the panel member included in the flexible image display device, reference can be made to the description of the panel member for the above-described touch sensor-equipped panel member. The panel member may include a protection member. As to the protection member as well, reference can be made to the description of the touch sensor-equipped panel member.

(Tacky Member)

The optical laminate or the flexible image display device includes a plurality of layers of tacky members. Each of the tacky members is usually in the form of a layer.

Each of the plurality of layers of tacky members is disposed at a position selected from a position inside the window member, a position inside the optical film, a position between the window member and the member A (or the optical film), a position between the member A and the member B, a position between the member B and the separator, and a position between the optical film and the separator, depending on the layer configuration of the optical laminate, for example.

Each of the plurality of layers of tacky members is disposed at a position selected from a position inside the window member, a position inside the optical film, a position between the window member and the member A (or the optical film), a position between the member A and the member B, a position between the member B and the member C, and a position between the optical film and the touch sensor-equipped panel member, depending on the layer configuration of the flexible image display device, for example.

Thus, the tacky members (i.e., the plurality of layers of tacky members) included in the flexible image display device or the optical laminate encompass both a tacky member included between adjacent members and a tacky member included inside each of the members.

The number of layers of tacky members inside each of the members is not particularly limited, and may be zero, one, or two or more.

The number of layers of tacky members included in the flexible image display device or the optical laminate may be, for example, eight or less, seven or six or less, or five or four or less.

The flexible image display device or the optical laminate is produced, for example, by laminating the constituent members with a tacky member disposed between the members (and between the layers constituting each member if necessary). At this time, another member or layer is laminated, via a tacky member, to a member or layer in which the decoration layer is provided at the desired position, whereby the flexible image display device or the optical laminate including a decorated laminate is produced. Alternatively, after a decorated laminate has been produced, other constituent members, layers, or a laminate thereof constituting the flexible image display device or the optical laminate may be laminated with the decorated laminate. The order of lamination of the members and the layers is not particularly limited.

For example, the window member and the member A (or the optical film) may be laminated in a state in which a tacky member is interposed between these members, and then the member A (or the optical film) and the member B (or the separator) may be laminated in a state in which a tacky member is interposed between these members. Alternatively, after the member A (or the optical film) and the member B (or the separator) have been laminated in a state in which a tacky member is interposed between these members, the member A (or the optical film) and the window member may be laminated in a state in which a tacky member is interposed between these members. Each of the tacky members is preferably attached in advance to one of the members that sandwich the tacky member.

For the optical laminate, a tacky member may be disposed on a surface of the member B on a side opposite to the member A side before lamination of the member B with the member A. Alternatively, a tacky member may be disposed on the surface of the member B on a side opposite to the member A side at a suitable stage after lamination of the member B with the member A. For the optical laminate, the separator is laminated to the tacky member disposed on the surface of the member B on the side opposite to the member A side before or after the disposition of the tacky member on the surface of the member B.

The flexible image display device may be produced by producing an optical laminate in advance, detaching the separator from the optical laminate, and attaching the exposed tacky member to the member C or the member B. Alternatively, the flexible image display device may be produced by laminating the member C and the member B such that a tacky member is interposed therebetween, thereafter laminating the member A to the member B such that a tacky member is interposed therebetween, and then laminating the window member to the member A such that a tacky member is interposed therebetween. Alternatively, a laminate of the member C and the member B and a laminate of the window member and the member A may be produced in advance, and these laminates may be laminated in a state in which a tacky member is interposed between the member A and the member B. A flexible image display device including a touch sensor-equipped panel member may be produced, for example, by producing an optical laminate in advance, detaching the separator from the optical laminate, and attaching the exposed tacky member to an optical film. Alternatively, the flexible image display device may be produced by laminating a window member and an optical film such that a tacky member is interposed therebetween, and thereafter laminating a touch sensor-equipped panel member to the optical film such that a tacky member is interposed therebetween. The flexible image display device may be produced by laminating a touch sensor-equipped panel member and an optical film such that a tacky member is interposed therebetween, and thereafter laminating a window member to the optical film such that a tacky member is interposed therebetween.

These production methods are merely examples, and the present invention is not limited thereto.

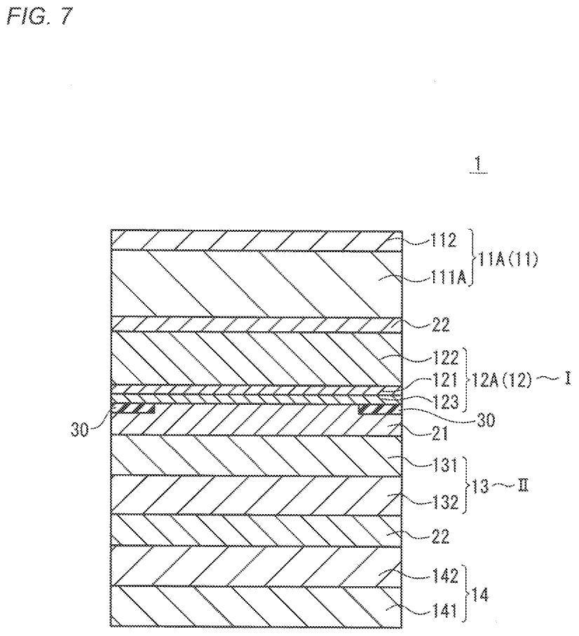

FIG. 7 is a schematic cross-sectional view of a flexible image display device according to an embodiment. A flexible image display device 1 includes a laminate of a window member 11, an optical film 12 as a member A, a touch sensor 13 as a member B, and a panel member 14 as a member C. The optical film 12 and the window member 11 are laminated in a state in which a tacky member (second tacky member) 22 is interposed between the optical film 12 and the window member 11. The touch sensor 13 is laminated to the window member 11 via the optical film 12. A tacky member (first tacky member) 21 is interposed between the optical film 12 and the touch sensor 13. The panel member 14 is laminated to the window member 11 via the optical film 12 and the touch sensor 13. A tacky member (second tacky member) 22 is interposed between the touch sensor 13 and the panel member 14. A laminate of the configuration in FIG. 7 except for the panel member 14 and a separator (not shown) corresponds to the optical laminate. In the optical laminate, the separator is disposed so as to be in contact with the tacky member 22 disposed on a side opposite to the viewing side of the touch sensor 13. The window member 11 and the optical film 12 are the same as those shown in FIG. 2.

The touch sensor 13 includes a transparent conductive layer 131, and a transparent film (touch sensor film) 132 as a transparent base material. The touch sensor 13 is disposed such that the transparent conductive layer 131 is in contact with the tacky member 21 (first tacky member) disposed between the optical film 12 and the touch sensor 13.

The panel member 14 includes an organic EL panel (organic EL display) 141 and a thin-film sealing layer 142. The panel member 14 is disposed such that the thin-film sealing layer 142 is in contact with the tacky member (second tacky member) 22 disposed between the touch sensor 13 and the panel member 14.

In FIG. 7, the optical film 12 corresponds to a first member I of a decorated laminate, and the touch sensor 13 corresponds to a second member II thereof. The tacky member 21 is interposed between the first member I and the second member II. In FIG. 7, a frame-shaped decoration layer 30 is provided on a surface of the first member I on the second member II side in a state in which the decoration layer 30 is in contact with the first tacky member 21. However, the embodiment is not limited to this case, and the decoration layer 30 may be provided on a surface of the second member II on the first member I side. By controlling the relationship in terms of deformation or hardness between the first member I and the second member II in the above-described manner, excessive deformation of the second member II caused by disposition of the decoration layer 30 is suppressed, making it possible to enhance the appearance of the flexible image display device 1 in the case of including the decoration layer 30.

### EXAMPLES

Hereinafter, the present invention will be specifically described by way of examples and comparative examples. However, the present invention is not limited to the following examples.

### Examples 1 to 5 and Comparative Examples 1 to 2

(1) Production of Evaluation Sample

Using the following members, evaluation samples of decorated laminates as shown in FIGS. 2 to 6 and FIGS. 9A and 9B were produced in accordance with the following procedure.

(i) Preparation of Window Member and Optical film or Layers or Laminate constituting These, and Separator

(a) Window Member 11

(a1) Laminate (or Window Member) 11A of Layers Constituting Window Member

As the window member 11A, a window member obtained by providing an acrylic hard coat layer 112 (thickness: 10 μm) on one side of a transparent polyimide film as a window film 111A was used. The hard coat layer 112 was formed using a coating agent for hard coat layers. More specifically, first, the coating agent was applied to one side of the transparent polyimide film to form a coated layer, and the coated layer was heated together with the transparent polyimide film at 90° C. for 2 minutes. Then, using a high-pressure mercury lamp, the coated layer was irradiated with ultraviolet light at an accumulated light amount of 300 mJ/cm², thereby forming a hard coat layer 112. Thus, a laminate 11A was produced. The elastic modulus of the laminate 11A as determined in a way similar to that as described above for the first member or the second member was 6.3 GPa.

As the transparent polyimide film, a product name “A_50_O” manufactured by KOLON Inc., having a thickness of 80 was used. The hardness of the laminate 11A was 6.3 GPa×0.09 mm=0.57 kN/mm.

Note that the coating agent for hard coat layers was prepared by mixing 100 parts by mass of a multifunctional acrylate (a product name “Z-850-16” manufactured by AICA Kogyo Co., Ltd.) as a base resin, 5 parts by mass of a leveling agent (trade name: GRANDIC PC-4100, manufactured by DIC Corporation), and 3 parts by mass of a photo-polymerization initiator (trade name: Irgacure 907, manufactured by Ciba Japan K.K), and diluting the mixture with methyl isobutyl ketone to a dry solids concentration of 50 mass %.

(a2) Laminate 11B of Layers Constituting Window Member 11

As the window film 111B, an acrylic film (thickness: 40 μm) obtained by molding pellets of a methacrylic resin having a glutarimide ring unit into a film form by extrusion molding, followed by stretching, was used. The window film 111B having an acrylic hard coat layer 112 (thickness: 10 μm) formed on one side thereof was used as the laminate 11B constituting the window member 11. The hard coat layer 112 was produced in the same manner as the hard coat layer 112 of the window member 11A.

The elastic modulus of the laminate 11B as determined in a way similar to that as described above for the first member or the second member was 3.0 GPa, and the hardness was 3.0 GPa×0.05 mm=0.15 kN/mm.

(a3) Layer 11C Constituting Window Member 11

A glass substrate having a thickness of 30 μm was provided as a layer 11C (window glass 111C) constituting the window member 11.

The elastic modulus of the layer 11C as determined in a way similar to that as described above for the first member or the second member was 75 GPa, and the hardness was 75 GPa×0.03 mm=2.25 kN/mm.

(b) Optical Film 12

Each of the optical films 12, or layers constituting the optical film 12 or a laminate thereof was prepared in accordance with the following procedure.

(b1) Laminate 12A of Layers Constituting Optical Film

(Production of Polarizer 121)

An amorphous polyethylene terephthalate film (thickness: 100 μm) containing 7 mol % of an isophthalic acid unit was prepared as a base material made of a thermoplastic resin, and corona discharge treatment was performed on the surface of the film with an output discharge amount of 58 W/m²·min.

A polyvinyl alcohol (degree of polymerization: 4200, saponification degree: 99.2%) to which 1 mass % of an acetoacetyl-modified polyvinyl alcohol (trade name: GOHSEFIMER Z200 (average degree of polymerization: 1200, saponification degree: 98.5 mol %, acetoacetylation degree: 5 mol %, manufactured by The Nippon Synthetic Chemical Industry Co., Ltd.)) had been added was provided, and an aqueous coating liquid containing 5.5 mass % of thus provided polyvinyl alcohol (PVA)-based resin was provided.

The coating liquid was applied onto the surface of the base material so as to provide a film thickness after drying of 12 and the whole was dried for 10 minutes by hot-air drying under an atmosphere of 60° C., thereby producing a laminate in which a layer of the PVA-based resin had been provided on the base material.

The obtained laminate was first stretched 1.8 times by free end stretching in the air (auxiliary stretching in air) at 130° C., to form a stretched laminate. Next, the stretched laminate was immersed in an insolubilizing aqueous boric acid solution having a solution temperature of 30° C. for 30 seconds, thereby performing a step of insolubilizing the PVA layer in which the PVA molecules contained in the stretched laminate had been oriented. The insolubilizing aqueous boric acid solution in this step is an aqueous boric acid solution having a boric acid content of 3 parts by mass per 100 parts by mass of water. The stretched laminate was dyed to form a colored laminate. The colored laminate was obtained by immersing the stretched laminate in a dyeing solution containing iodine and potassium iodide and having a solution temperature of 30° C. for a predetermined time such that the PVA layer constituting a finally produced polarizer had a single transmittance of 40 to 44%, thereby allowing the PVA layer included in the stretched laminate to be dyed with iodine. In this step, the dyeing solution is an aqueous solution containing iodine and potassium iodide (iodine concentration: 0.1 to 0.4 mass %, potassium iodide concentration: 0.7 to 2.8 mass %, ratio of iodine concentration and potassium iodide concentration: 1:7). Next, the colored laminate was immersed in a crosslinking aqueous boric acid solution at 30° C. for 60 seconds, thereby performing a step of crosslinking the PVA molecules of the PVA layer having iodine adsorbed thereto. The crosslinking aqueous boric acid solution in this step is an aqueous solution containing boric acid and potassium iodide (boric acid content: 3 parts by mass per 100 parts by mass of water, potassium iodide content: 3 parts by mass per 100 parts by mass of water).

The obtained colored laminate was stretched (in-boric-acid-solution stretching) 3.05 times in an aqueous boric acid solution at a stretching temperature of 70° C. in the same direction as in the above-described stretching in the air, thereby obtaining a laminate with a final stretching ratio of 5.50 times. The obtained laminate was taken out from the aqueous boric acid solution, and the boric acid attached to the surface of the PVA layer was washed with an aqueous potassium iodide solution (potassium iodide content: 4 parts by mass per 100 parts by mass of water). The washed laminate was dried by a drying step using a warm air of 60° C. The thickness of the polarizer 121 included in the dried laminate was 5 μm.

(Formation of Protection Film 122)

As the protection film (transparent resin film) 122, an acrylic film obtained by molding pellets of a methacrylic resin having a glutarimide ring unit into a film form by extrusion molding, followed by stretching, was used. The thickness of the protection film was 40 μm. The protection film 122 and the polarizer 121 were bonded together using an adhesive (active energy ray-curable adhesive), and the adhesive was cured by being irradiated with ultraviolet light under the following conditions, thereby producing a polarizing plate.

Gallium-doped metal halide lamp: trade name “Light HAMMER10”, manufactured by Fusion UV Systems. Inc.

Valve: V valve

Peak illuminance: 1600 mW/cm²

Accumulated dose: 1000 mJ/cm² (wavelength: 380 to 440 nm)

The adhesive was prepared by mixing the following components such that their respective contents in 100 mass % of the adhesive had the following values, and stirring the mixture at 50° C. for one hour.

Hydroxyethyl acrylamide . . . 11.4 mass %

Tripropylene glycol diacrylate . . . 57.1 mass %

Acryloylmorpholine . . . 11.4 mass %

2-Acetoacetoxyethyl methacrylate . . . 4.6 mass %

Acrylic polymer (ARUFON UP-1190, manufactured by Toagosei Co., Ltd.) . . . 11.4 mass %

2-Methyl-1-(4-methylthiophenyl)-2-morpholino propane-1-one . . . 2.8 mass %

Diethylthioxanthone . . . 1.3 mass %

(Production of Retardation Layer 123)

As the retardation layer 123, a retardation film including two layers, namely, a quarter-wave-plate retardation layer and a half-wave-plate retardation layer in which a liquid crystal material had been oriented and immobilized. As the material for forming the half-wave-plate retardation layer and the quarter-wave-plate retardation layer, a polymerizable liquid crystal material (trade name: Paliocolor LC242, manufactured by BASF) exhibiting a nematic liquid crystalline phase was used. The retardation layer 123 was produced with reference to the description in paragraphs [0118] to [0120] of Japanese Laid-Open Patent Publication No. 2018-28573.

(Production of Laminate 12A)

The polarizing plate and the retardation layer 123 obtained as above were continuously bonded together by a roll-to-roll method, using the above-described adhesive (active energy ray-curable adhesive). At this time, the lamination was performed such that the axial angle between the slow axis and the absorption axis was 45°. Thus, a laminate 12A of the layers constituting the optical film was produced. The elastic modulus of the laminate 12A as determined in a way similar to that as described above for the first member or the second member was 5.0 GPa, and the hardness was 5.0 GPa×0.05 mm=0.25 kN/mm.

(b2) Layer 12B Constituting Optical film

A transparent resin film 122 was produced in accordance with the procedure described in (b1), and was used as a layer 12B constituting the optical film.

The elastic modulus of the layer 12B as determined in a way similar to that as described above for the first member or the second member was 3.0 GPa, and the hardness was 3.0 GPa×0.04 mm=0.12 kN/mm.

(b3) Laminate 12C Constituting Optical Film A laminate (polarizing plate) of a polarizer 121 and a protection film (transparent resin film) 122 was produced in accordance with the procedure described in (b1), and was used as a laminate 12C constituting the optical film.

The elastic modulus of the laminate 12C as determined in a way similar to that as described above for the first member or the second member was 4.9 GPa, and the hardness was 4.9 GPa×0.045 mm=0.22 kN/mm.

(b4) Laminate 12D Constituting Optical Film (Production of Retardation Film Constituting Retardation Layer 124) Polymerization was performed using a batch polymerizer composed of two vertical reactors each including a stirring blade and a reflux condenser controlled at 100° C. Into each of the reactors, 29.60 parts by mass (0.046 mol) of bis[9-(2-phenoxycarbonyl ethyl)fluoren-9-yl]methane (BPFM), 29.21 parts by mass (0.200 mol) of isosorbide (ISB), 42.28 parts by mass (0.139 mol) of spiroglycol (SPG), 63.77 parts by mass (0.298 mol) of diphenyl carbonate (DPC), and 1.19×10⁻² parts by mass (6.78×10⁻⁵ mol) of calcium acetate monohydrate as a catalyst were charged.

After reducing the pressure in the reactor and purging the reactor with nitrogen, the reactor was heated by using a heating medium, and stirring was started upon the temperature in the reactor reaching 100° C. After 40 minutes from the start of temperature elevation, the temperature in the reactor was allowed to reach 220° C., and the temperature in the reactor was controlled to maintain this temperature. Pressure reduction was started upon the temperature in the reactor reaching 220° C., and the pressure after 90 minutes was reduced to 13.3 kPa.

Phenol vapor produced as a by-product of the polymerization reaction was introduced into a reflux condenser at 100° C., then a slight amount of the monomer component contained in the phenol vapor was brought back to the reactor, and the phenol vapor that had not been condensed was introduced into a condenser at 45° C. for recovery. Nitrogen was introduced into a first reactor to restore the pressure to the atmospheric pressure once, and thereafter the oligomerized reaction liquid in the first reactor was transferred to a second reactor. Then, the temperature elevation and the pressure reduction in the second reactor were started. In 50 minutes, the temperature in the first reactor was increased to 240° C. and the pressure was reduced to 0.2 kPa. Thereafter, the polymerization was allowed to proceed until the stirring power reached a predetermined value. Upon the stirring power reaching the predetermined value, nitrogen was introduced into the reactor to restore the pressure, the produced polyester carbonate was extruded into water, and the resulting strand was cut to give pellets.

99.5 parts by mass of the obtained polyester carbonate and 0.5 parts by mass of polymethyl methacrylate (PMMA) were melt-kneaded using an extruder, to give pellets of a resin composition (PMMA content: 0.5 mass %). After being vacuum-dried at 80° C. for 5 hours, the resin composition (pellets) was subjected to film-forming using a film-forming apparatus including a single-screw extruder (manufactured by Isuzu Kakoki KK., screw diameter: 25 mm, cylinder set temperature: 220° C.), a T-die (width: 300 mm, set temperature: 220° C.), a chill roll (set temperature: 120 to 130° C.), and a winder, thereby producing a long unstretched film having a length of 3 m, a width of 200 mm, and a thickness of 100 nm. The obtained long unstretched film was stretched 2.7 times in the width direction (transverse direction) by uniaxial constrained stretching, to form a retardation film having a thickness of 37

(Production of Laminate Film Including Retardation Layer 125)

20 parts by mass of a side-chain liquid crystal polymer represented by the following chemical formula (I) (where numerals 65 and 35 each denote mol % of a monomer unit, the polymer is represented as a block polymer for convenience: weight-average molecular weight: 5000), 80 parts by mass of a polymerizable liquid crystal (trade name Paliocolor LC242, manufactured by BASF) exhibiting a nematic liquid crystalline phase, and 5 parts by mass of a photo-polymerization initiator (trade name Irgacure 907, manufactured by Ciba Specialty Chemicals) was dissolved in 200 parts by mass of cyclopentanone, to prepare a liquid crystal coating liquid.

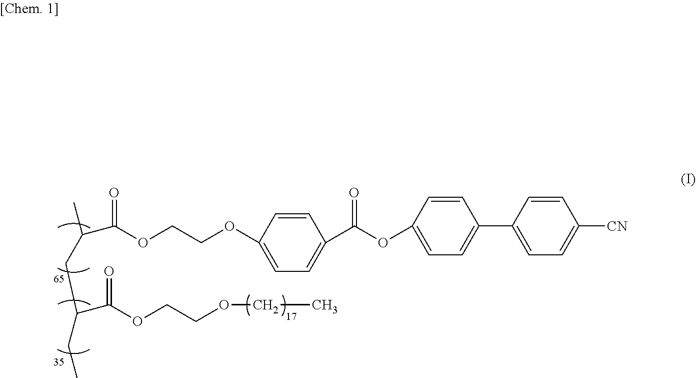

After the obtained liquid crystal coating liquid had been applied to a base material film (norbomene-series resin film: manufactured by ZEON CORPORATION, trade name “ZEONEX”) using a bar coater, the whole was heated and dried at 80° C. for 4 minutes, to orient the liquid crystal. This liquid crystal layer was irradiated with ultraviolet light to cure the liquid crystal layer, thereby forming a liquid crystal solidified layer (thickness: 0.58 pin) serving as a retardation layer 125 on the base material film. This layer exhibited a refractive index property of nz>nx=ny. Here, nx is a refractive index in a direction in which the in-plane refractive index of the liquid crystal solidified layer is maximum (i.e., a slow axis direction). ny is a refractive index in a direction orthogonal to the slow axis in a plane of the liquid crystal solidified layer (i.e., a fast axis direction). nz is a refractive index of the liquid crystal solidified layer in the thickness direction.

(Production of Laminate 12D)

The liquid crystal solidified layer of the laminate film was attached to one principal surface of the retardation film constituting the retardation layer 124 via an acrylic adhesive. Then, the base material film included in the laminate film was removed. Thus, a laminate 12D in which the retardation layer 124 and the retardation layer 125 corresponding to the liquid crystal solidified layer were laminated was produced.

The elastic modulus of the laminate 12D as determined in a way similar to that as described above for the first member or the second member was 3.7 GPa, and the hardness was 3.7 GPa×0.038 mm=0.14 kN/mm.

(b5) Layer 12E Constituting Optical Film 12

A glass substrate 126 having a thickness of 30 μm was provided as a layer 12E constituting the optical film 12. The elastic modulus of the layer 12E as determined in a way similar to that as described above for the first member or the second member was 75 GPa, and the hardness was 75 GPa×0.03 mm=2.25 kN/mm.

(c) Separator S

One principal surface of a transparent polyethylene terephthalate film having a thickness of 50 μm was treated with a silicone-containing release agent, thereby preparing a separator S. The elastic modulus Es of the separator S as determined in a way similar to that as described above for the first member or the second member was 4.2 GPa, and Es×Ts (=0.05 mm)=0.21 kN/mm.

(ii) Formation of Decoration Layer

On the surface of a member or layer on which the decoration layer 30 of the decorated laminate was to be provided, a frame-shaped black ink layer (width: 15 mm, thickness: 5 μm) was provided as a decoration layer 30 by screen printing. As the black ink, INQ-HF979 manufactured by Teikoku Printing Inks Mfg. Co., Ltd. was used.

(iii) Preparation of Tackiness Agent

An acrylic tackiness agent (acrylic tackiness agent composition) for producing the tacky members 21 and 22 was prepared in accordance with the following procedure.

(Preparation of Acrylic Oligomer)

60 parts by mass of dicyclopentanyl methacrylate and 40 parts by mass of methyl methacrylate as monomer components, 3.5 parts by mass of α-thioglycerol as a chain transfer agent, and 100 parts by mass of toluene as a polymerization solvent were mixed, and the mixture was stirred under a nitrogen atmosphere at 70° C. for one hour. Next, 0.2 parts by mass of 2,2′-azobisisobutyronitrile as a thermal polymerization initiator was charged into the mixture. After reacting the mixture for 2 hours at 70° C., the temperature was elevated to 80° C., and the mixture was reacted for 2 hours. Thereafter, the reaction liquid was heated to 130° C. to remove the toluene, the chain transfer agent, and the unreacted monomers by drying, thereby obtaining a solid acrylic oligomer. The acrylic oligomer had a weight-average molecular weight of 5100, and a glass transition temperature (Tg) of 130° C.

(Preparation of Prepolymer Composition)

43 parts by mass of lauryl acrylate, 44 parts by mass of 2-ethylhexyl acrylate, 6 parts by mass of 4-hydroxybutyl acrylate, and 7 parts by mass of N-vinyl-2-pyrrolidone, as well as 0.015 parts by mass of “Irgacure 184” manufactured by BASF as a photo-polymerization initiator were mixed, and the mixture was irradiated with ultraviolet light to perform polymerization, thereby obtaining a prepolymer composition (polymerization rate: about 10%).

(Preparation of Acrylic Tackiness Agent)

To 100 parts by mass of the above-described prepolymer composition, 0.07 parts by mass of 1,6-hexanediol diacrylate, 1 part by mass of the above-described acrylic oligomer, and 0.3 parts by mass of a silane coupling agent (“KBM403J” manufactured by Shin-Etsu Chemical Co., Ltd.) were added, and uniformly mixed, thereby preparing an acrylic tackiness agent.

(iv) Formation of Tackiness Agent Layer

Using the tackiness agent prepared in (iii) above, a tackiness agent layer for forming each of the tacky members 21 and 22 was formed. More specifically, the tackiness agent was uniformly applied to a release film using a fountain coater, and was dried for 2 minutes in an air circulated thermostatic oven at 155° C., to form a tackiness agent layer on the surface of the release film. As the release film, a 38 μm-thick polyethylene terephthalate film (transparent base material, separator) that had been treated with a silicone-containing release agent was used. The thickness of the tackiness agent layer was adjusted by adjusting the application amount of the tackiness agent such that the thickness of the tacky member 21 in each sample was 25 μm, and the thickness of the tacky member 22 in each sample was 15 μm. The storage modulus of the tacky member determined in accordance with the previously describe procedure was 0.3 MPa.

(v) Formation of Laminate

Each of the members produced in (i) above, or the layers or laminate thereof constituting each of the members was cut into a predetermined size as needed. The tackiness agent layer was transferred from the release film to one principal surface of one of the members or layers for sandwiching each of the tacky members, and the members or layers were laminated so as to sandwich the tackiness agent layer therebetween, and were pressure-bonded using a hand roller. Thus, evaluation samples in each of which the members or the layers or laminates were laminated using the tacky members were produced. Note that when a tacky member is brought into contact with the surface of the separator S, the tacky member is disposed such that a principal surface of the separator S that has been treated with the release agent is in contact with the tacky member.

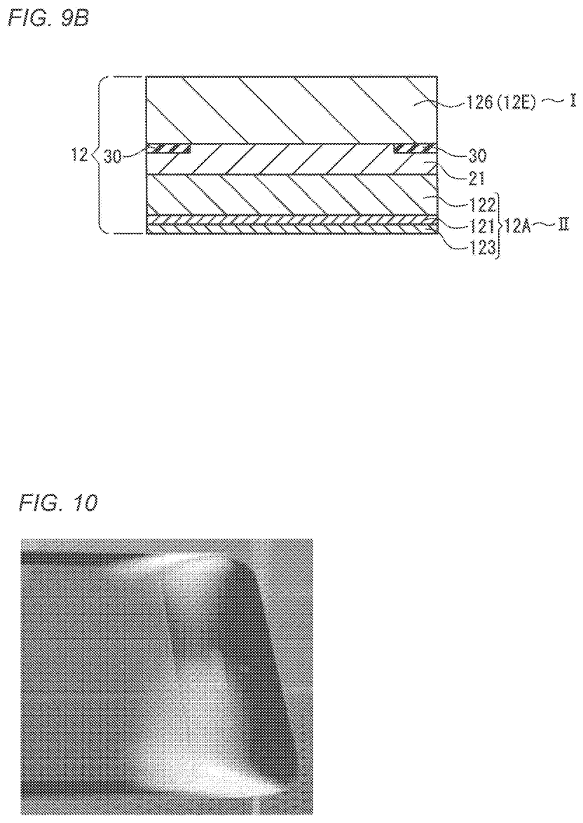

FIGS. 9A and 9B are schematic cross-sectional views of decorated laminates of Comparative Examples 1 and 2, respectively. The decorated laminate of FIG. 9A includes a laminate 11A of layers constituting a window member 11 as a first member I, a laminate 12A of layers constituting an optical film 12 as a second member II, and a tacky member 21 interposed therebetween. The decorated laminate of FIG. 9B includes a layer (glass substrate) 12E constituting an optical film 12 as a first member I, a laminate 12A of layers constituting an optical film 12 as a second member II, and a tacky member 21 interposed therebetween. In these decorated laminates, a frame-shaped decoration layer 30 is disposed on a surface of the first member I on the second member II side so as to be in contact with the tacky member 21. The configuration of the laminate 11A and the laminate 12A is the same as that in the case of FIG. 2.

(2) Evaluation

The appearance was evaluated as “B” if white shining lines were observed at inner side portions of the decoration layer 30 when each sample was viewed from the viewing side, or “A” if no white shining line was observed.

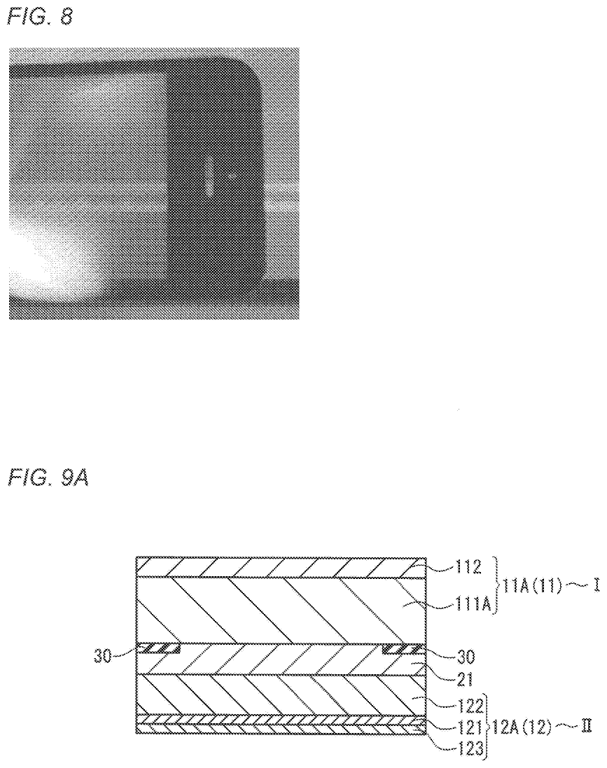

The results of the examples and the comparative examples are shown in Table 1. In Table 1, e1 to e5 are Examples 1 to 5, and r1 to r2 are Comparative Examples 1 to 2. FIG. 8 is a photograph of the decoration layer of the decorated laminate of Example 4 and the periphery of inner side portions thereof, taken from the viewing side. FIG. 10 is a photograph of the decoration layer of the decorated laminate of Comparative Example 1 and the periphery of inner side portions thereof, taken from the viewing side.

TABLE 1

| | | e1 | e2 | e3 | e4 | e5 | r1 | r2 |
|---|---|---|---|---|---|---|---|---|
| Layer configuration | | FIG. 3 | FIG. 4 | FIG. 2 | FIG. 5 | FIG. 6 | FIG. 8A | FIG. 8B |
| First | B1-A1 (μm) | 6 | 5 | 3 | 2 | 2 | 0 | 0 |
| member | R1 = E1 × T1 | 0.15 | 0.12 | 0.25 | 0.22 | 0.22 | 0.57 | 2.25 |
| | (kM/mm) | | | | | | | |
| Second | B2-A2 (μm) | 0 | 1 | 3 | 4 | 4 | 6 | 6 |
| member | R2 = E2 × T2 | 2.25 | 0.25 | 0.21 | 0.14 | 0.14 | 0.25 | 0.25 |
| | (kM/mm) | | | | | | | |

| | | | | | | | |
|---|---|---|---|---|---|---|---|
| Position of decoration | First | First | First | Second | First | First | First |
| layer | member | member | member | member | member | member | member |
| R2/R1 | 15.00 | 2.08 | 0.84 | 0.64 | 0.64 | 0.44 | 0.11 |
| Appearance | A | A | A | A | A | B | B |

As shown in FIG. 10, for r1, a white shining line was observed in the vicinity of the inner side portion of the decoration layer 30. For r2 as well, a white shining line was observed as in the case of r1. In contrast, as shown in FIG. 8, for e4, no white shining line was observed in the vicinity of the inner side portions of the decoration layer 30, and a favorable appearance was ensured. For the other Examples e1 to e3 and e5 as well, a favorable appearance was confirmed as in the case of e4. Such a difference in the results between the comparative examples and the examples is considered to be due to the fact that the deformation of the second member II was reduced as a result of controlling the balance of deformation or hardness between the first member I and the second member II.

A1 though the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### INDUSTRIAL APPLICABILITY

The decorated laminate and the optical laminate can be used for a flexible image display device.

### REFERENCE SIGNS LIST

1: Flexible image display device
11: Window member
11A, 11B, 11C: Layers or laminates constituting window member
111A, 111B: Window film
111C: Window glass
112: Hard coat layer
12: Optical film
12A to 12E: Layers or laminates constituting optical film
121: Polarizer
122: Protection film (transparent resin film)
123 to 125: Retardation layer
126: Glass substrate
13: Touch sensor
131: Transparent conductive layer
132: Transparent film
14: Panel member
141: Organic EL panel
142: Thin-film sealing layer
21: Tacky member (first tacky member)
22: Tacky member (second tacky member)
30: Decoration layer
S: Separator
I: First member
II: Second member

1. A decorated laminate for use in a flexible image display device, the decorated laminate comprising:
a first member; a second member; a tacky member sandwiched between the first member and the second member; and a decoration layer provided so as to be in contact with the tacky member,
wherein the first member is disposed closer to a viewing side than the second member in the flexible image display device,
the first member and the second member do not include the tacky member, and,
where L10 is a position in a lamination direction of an interface between the first member and the tacky member at a center of the first member when the first member is viewed from the viewing side in a state in which the decorated laminate is placed flat, L11 is a position in the lamination direction of a surface of the first member on the viewing side at the center, and L12 is a position closest to the viewing side of a portion of the first member that opposes the decoration layer, a height A1 from L10 to L11 and a height B1 from L10 to L12 satisfy a condition of A1<B1,
where L20 is a position in the lamination direction of an interface between the second member and the tacky member at a center of the second member when the second member is viewed from the viewing side, L21 is a position in the lamination direction of a surface of the second member on a side opposite to the viewing side at the center, L22 is a position farthest from the viewing side of a portion of the second member that opposes the decoration layer, A2 is a height from L20 to L21, and B2 is a height from L20 to L22,
a condition of (B2−A2)≤5 μm is satisfied.

2. The decorated laminate according to claim 1,
wherein a condition of (B1−A1)≥1 μm is satisfied.

3. The decorated laminate according to claim 6,
wherein, where L20 is a position in the lamination direction of an interface between the second member and the tacky member at a center of the second member when the second member is viewed from the viewing side, L21 is a position in the lamination direction of a surface of the second member on a side opposite to the viewing side at the center, L22 is a position farthest from the viewing side of a portion of the second member that opposes the decoration layer, A2 is a height from L20 to L21, and B2 is a height from L20 to L22,
a condition of (B2−A2)≤5 μm is satisfied.

4. The decorated laminate according to claim 1,
wherein, where L20 is a position in the lamination direction of an interface between the second member and the tacky member at a center of the second member when the second member is viewed from the viewing side, L21 is a position in the lamination direction of a surface of the second member on a side opposite to the viewing side at the center, L22 is a position farthest from the viewing side of a portion of the second member that opposes the decoration layer, A2 is a height from L20 to L21, and B2 is a height from L20 to L22,
a condition of (B1−A1)≥(B2−A2) is satisfied.

5. The decorated laminate according to claim 1,
wherein, where E1 is an elastic modulus (GPa) of the first member, and T1 is a thickness (mm) of the first member, a hardness R1 of the first member that is represented by E1×T1 satisfies a condition of 0.5 kN/mm or less.

6. A decorated laminate for use in a flexible image display device, the decorated laminate comprising:
a first member; a second member; a tacky member sandwiched between the first member and the second member; and a decoration layer provided so as to be in contact with the tacky member,
wherein the first member is disposed closer to a viewing side than the second member in the flexible image display device,
the first member and the second member do not include the tacky member, and,
where L10 is a position in a lamination direction of an interface between the first member and the tacky member at a center of the first member when the first member is viewed from the viewing side in a state in which the decorated laminate is placed flat, L11 is a position in the lamination direction of a surface of the first member on the viewing side at the center, and L12 is a position closest to the viewing side of a portion of the first member that opposes the decoration layer, a height A1 from L10 to L11 and a height B1 from L10 to L12 satisfy a condition of A1<B1, where E1 and E2 are elastic moduli (GPa) of the first member and the second member, respectively, and T1 and T2 are thicknesses (mm) of the first member and the second member, respectively, a ratio: R2/R1 of a hardness R2 of the second member that is represented by E2×T2 to a hardness R1 of the first member that is represented by E1×T1 satisfies a condition of R2/R1≥0.5.

7. The decorated laminate according to claim 6,
wherein, where E1 and E2 are elastic moduli (GPa) of the first member and the second member, respectively, and T1 and T2 are thicknesses (mm) of the first member and the second member, respectively,
a hardness R1 (kN/mm) of the first member that is represented by E1×T1 satisfies 0.01≤R1≤2.5, and
a hardness R2 (kN/mm) of the second member that is represented by E2×T2 satisfies 0.01≤R2≤2.5.

8. The decorated laminate according to claim 6,
wherein, where E1 and E2 are elastic moduli (GPa) of the first member and the second member, respectively, and T1 and T2 are thicknesses (mm) of the first member and the second member, respectively, a ratio: R2/R1 of a hardness R2 of the second member that is represented by E2×T2 to a hardness R1 of the first member that is represented by E1×T1 satisfies a condition of R2/R1>2.

9. The decorated laminate according to claim 6,
wherein, where E1 and E2 are elastic moduli (GPa) of the first member and the second member, respectively, and T1 and T2 are thicknesses (mm) of the first member and the second member, respectively, a ratio: R2/R1 of a hardness R2 of the second member that is represented by E2×T2 to a hardness R1 of the first member that is represented by E1×T1 satisfies a condition of 0.5≤R2/R1≤2, and
each of the hardness R1 and the hardness R2 satisfies a condition of 0.5 kN/mm or less.

10. The decorated laminate according to claim 1,
wherein a storage modulus at 25° C. of the tacky member satisfies a condition of 1 MPa or less.

11. The decorated laminate according to claim 1,
wherein a thickness of the decoration layer satisfies a condition of 20 μm or less.

12. The decorated laminate according to claim 1,
wherein a thickness of the tacky member with which the decoration layer is in contact satisfies a condition of 1.5 times or more of a thickness of the decoration layer, and satisfies a condition of 50 μm or less.

13. The decorated laminate according to claim 1,
wherein the first member constitutes a window member or an optical film, and
the second member constitutes a window member, an optical film, a touch sensor, a touch sensor-equipped panel member, or a separator.

14. An optical laminate comprising the decorated laminate according to claim 1,
the optical laminate comprising:
a window member;
a member A laminated to the window member;
a member B laminated to the window member via the member A;
a separator laminated to the window member via the member A and the member B; and
a plurality of layers of tacky members including the tacky member in contact with the decoration layer,
wherein one of the member A and the member B is an optical film, and the other is a touch sensor,
the first member constitutes the window member or the optical film,
the second member constitute the window member, the optical film, the touch sensor, or the separator, and
the decoration layer is provided closer to the viewing side than the touch sensor.

15. An optical laminate comprising the decorated laminate according to claim 1,
the optical laminate comprising:
a window member;
an optical film laminated to the window member;
a separator laminated to the window member via the optical film; and
a plurality of layers of tacky members including the tacky member in contact with the decoration layer,
wherein the first member constitutes the window member or the optical film,
the second member constitutes the window member, the optical film, or the separator, and
the decoration layer is provided closer to the viewing side than the separator.

16. A flexible image display device comprising the decorated laminate according to claim 1,
the flexible image display device comprising:
a window member;
a member A laminated to the window member;
a member B laminated to the window member via the member A;
a member C laminated to the window member via the member A and the member B; and
a plurality of layers of tacky members including the tacky member in contact with the decoration layer,
wherein one of the member A and the member B is an optical film, and the other is a touch sensor,
the member C includes at least a panel member,
the first member constitutes the window member or the optical film,
the second member constitute the window member, the optical film, or the touch sensor, and
the decoration layer is provided closer to the viewing side than the touch sensor.

17. A flexible image display device comprising the decorated laminate according to claim 1,
the flexible image display device comprising:
a window member;
an optical film laminated to the window member;
a touch sensor-equipped panel member laminated to the window member via the optical film; and
a plurality of layers of tacky members including the tacky member in contact with the decoration layer,
wherein the first member constitutes the window member or the optical film, the second member constitutes the window member, the optical film, or the touch sensor-equipped panel member, and
the decoration layer is provided closer to the viewing side than the touch sensor-equipped panel member.

18. The decorated laminate according to claim 2,
wherein, where E1 is an elastic modulus (GPa) of the first member, and T1 is a thickness (mm) of the first member,
a hardness R1 (kN/mm) of the first member that is represented by E1×T1 satisfies 0.01≤R1≤2.5, and
a hardness R2 (kN/mm) of the second member that is represented by E2×T2 satisfies 0.01≤R2≤2.5.

19. The decorated laminate according to claim 2,
wherein where E1 and E2 are elastic moduli (GPa) of the first member and the second member, respectively, and T1 and T2 are thicknesses (mm) of the first member and the second member, respectively, a ratio: R2/R1 of a hardness R2 of the second member that is represented by E2×T2 to a hardness R1 of the first member that is represented by E1×T1 satisfies a condition of R2/R1>2.

20. The decorated laminate according to claim 2,
wherein, where E1 and E2 are elastic moduli (GPa) of the first member and the second member, respectively, and T1 and T2 are thicknesses (mm) of the first member and the second member, respectively, a ratio: R2/R1 of a hardness R2 of the second member that is represented by E2×T2 to a hardness R1 of the first member that is represented by E1×T1 satisfies a condition of 0.5≤R2/R1≤2, and
each of the hardness R1 and the hardness R2 satisfies a condition of 0.5 kN/mm or less.

21. The decorated laminate according to claim 3,
wherein, where L20 is a position in the lamination direction of an interface between the second member and the tacky member at a center of the second member when the second member is viewed from the viewing side, L21 is a position in the lamination direction of a surface of the second member on a side opposite to the viewing side at the center, L22 is a position farthest from the viewing side of a portion of the second member that opposes the decoration layer, A2 is a height from L20 to L21, and B2 is a height from L20 to L22,
a condition of (B1−A1)≥(B2−A2) is satisfied.

22. The decorated laminate according to claim 6,
wherein a condition of (B1−A1)≥1 μm is satisfied.

23. The decorated laminate according to claim 6,
wherein, where E1 is an elastic modulus (GPa) of the first member, and T1 is a thickness (mm) of the first member, a hardness R1 of the first member that is represented by E1×T1 satisfies a condition of 0.5 kN/mm or less.

24. The decorated laminate according to claim 6,
wherein a storage modulus at 25° C. of the tacky member satisfies a condition of 1 MPa or less.

25. The decorated laminate according to claim 6,
wherein a thickness of the decoration layer satisfies a condition of 20 μm or less.

26. The decorated laminate according to claim 6,
wherein a thickness of the tacky member with which the decoration layer is in contact satisfies a condition of 1.5 times or more of a thickness of the decoration layer, and satisfies a condition of 50 μm or less.

27. The decorated laminate according to claim 6,
wherein the first member constitutes a window member or an optical film, and
the second member constitutes a window member, an optical film, a touch sensor, a touch sensor-equipped panel member, or a separator.

28. An optical laminate comprising the decorated laminate according to claim 6,
the optical laminate comprising:
a window member;
a member A laminated to the window member;
a member B laminated to the window member via the member A;
a separator laminated to the window member via the member A and the member B; and
a plurality of layers of tacky members including the tacky member in contact with the decoration layer,
wherein one of the member A and the member B is an optical film, and the other is a touch sensor,
the first member constitutes the window member or the optical film,
the second member constitute the window member, the optical film, the touch sensor, or the separator, and
the decoration layer is provided closer to the viewing side than the touch sensor.

29. An optical laminate comprising the decorated laminate according to claim 6,
the optical laminate comprising:
a window member;
an optical film laminated to the window member;
a separator laminated to the window member via the optical film; and
a plurality of layers of tacky members including the tacky member in contact with the decoration layer,
wherein the first member constitutes the window member or the optical film,
the second member constitutes the window member, the optical film, or the separator, and
the decoration layer is provided closer to the viewing side than the separator.

30. A flexible image display device comprising the decorated laminate according to claim 6,
the flexible image display device comprising:
a window member;
a member A laminated to the window member;
a member B laminated to the window member via the member A;
a member C laminated to the window member via the member A and the member B; and
a plurality of layers of tacky members including the tacky member in contact with the decoration layer,
wherein one of the member A and the member B is an optical film, and the other is a touch sensor,
the member C includes at least a panel member,
the first member constitutes the window member or the optical film,
the second member constitute the window member, the optical film, or the touch sensor, and
the decoration layer is provided closer to the viewing side than the touch sensor.

31. A flexible image display device comprising the decorated laminate according to claim 6,
the flexible image display device comprising:
a window member;
an optical film laminated to the window member;
a touch sensor-equipped panel member laminated to the window member via the optical film; and
a plurality of layers of tacky members including the tacky member in contact with the decoration layer,
wherein the first member constitutes the window member or the optical film,
the second member constitutes the window member, the optical film, or the touch sensor-equipped panel member, and
the decoration layer is provided closer to the viewing side than the touch sensor-equipped panel member.
